(19) United States
(12) Patent Application Publication
(10) Pub. No.: US 2011/0229662 A1
(43) Pub. Date: Sep. 22, 2011

(54) Polymer film, production method for the film, and retardation film, polarizing plate and liquid-crystal display device having the film

(75) Inventors: Hiroko Kamee, Minami-ashigara-shi (JP); Akihiro Matsufuji, Minami-ashigara-shi (JP); Shunya Katoh, Minami-ashigara-shi (JP)

(73) Assignee: FUJIFILM Corporation, Tokyo (JP)

(21) Appl. No.: 13/064,221

(22) Filed: Mar. 11, 2011

(30) Foreign Application Priority Data
Mar. 11, 2010 (JP) 2010-054064

(51) Int. Cl. C09K 19/00; B29D 11/00; F21V 9/06; G02B 5/30

(52) U.S. Cl. 428/1.3; 264/1.6; 252/589; 359/483.01

(57) ABSTRACT

A polymer film comprising at least one polymer as the main ingredient thereof, and at least one compound that satisfies relational formulae (1) and (2), in an amount of from 0.2 to 20% by mass of said at least polymer is disclosed. λmax indicates the maximum absorption wavelength (unit: nm) of the compound, λ_{1/2} (λmax<λ_{1/2}) indicates the wavelength at which the absorption intensity at λmax is ½.

360 nm≦λmax≦400 nm (1)

λ_{1/2}−λmax≦20 nm (2)

### CROSS-REFERENCE TO RELATED APPLICATIONS

The present application claims the benefit of priority from Japanese Patent Application No. 2010-054064, filed on Mar. 11, 2010, the contents of which are herein incorporated by reference in their entirety.

### BACKGROUND OF THE INVENTION

1. Field of the Invention

The present invention relates to a polymer film useful as members of liquid-crystal display devices, etc., and to a production method for the film. The invention also relates to a retardation film, a polarizing plate and a liquid-crystal display device having the polymer film.

2. Background Art

Heretofore, adding various additives to optical films for use in liquid-crystal display devices for regulating the optical properties thereof has been tried. In particular, a biaxial film of which retardation in plane Re exhibits revered wavelength dispersion characteristics and retardation along the thickness direction Rth exhibits regular wavelength dispersion characteristics is useful as an optically compensatory film for use in liquid-crystal display devices; and for producing the film having such characteristics, adding a UV absorbent to the film has been tried. For example, JP-A 2009-64007 and 2009-64006 disclose a transparent polymer film such as a cellulose acylate film or the like, to which a compound having at least one absorption maximum in a wavelength range of from 300 to 380 nm has been added and which has reversed wavelength dispersion characteristics of Re and regular wavelength dispersion characteristics of Rth.

### SUMMARY OF THE INVENTION

However, the present inventors' investigations have revealed that, when a compound having an absorption maximum in a relatively long wavelength region of a UV range of from 300 to 380 nm is added to the polymer film, then the film may often yellows, which therefore would be a bar to its use as members of display devices that require high transmittance of visible light.

An object of the invention is to provide a polymer film with no coloration and useful as optically compensatory film for liquid-crystal display devices.

Another object of the invention is to provide a polymer film with no coloration, of which retardation in plane exhibits reversed wavelength dispersion characteristics and retardation along the thickness direction exhibits regular wavelength dispersion characteristics.

Still another object of the invention is to provide a retardation film, a polarizing plate and a liquid-crystal display device comprising the polymer film.

The means for achieving the above-mentioned objects are as follows.

### [1] A POLYMER FILM COMPRISING

at least one polymer as the main ingredient thereof, and

at least one compound that satisfies relational formulae (1) and (2), in an amount of from 0.2 to 20% by mass of said at least polymer; and

of which retardation in plane at a wavelength of λnm, Re(λ), and retardation along the thickness direction at a wavelength of λnm, Rth(λ) satisfy formulae (3), (4), (5) and (6):

360 nm≦λmax≦400 nm (1)

λ_{1/2}−λmax≦20 nm (2)

wherein λmax indicates the maximum absorption wavelength (unit: nm) of the compound, λ_{1/2} (λmax<λ_{1/2}) indicates the wavelength at which the absorption intensity at λmax is ½,

Re(450)−Re(550)≦0 nm (3)

Rth(450)−Rth(550)≧0 nm (4)

60 nm≦Re(550)≦100 nm (5)

40 nm≦Rth(550)≦80 nm (6)

[2] The polymer film of [1], satisfying formulae (3′) and (4′):

−150 nm≦Re(450)−Re(550)≦0 nm (3′)

150 nm≧Rth(450)−Rth(550)≧0 nm (4′)

[3] The polymer film of [1], satisfying formulae (3″) and (4″):

−50 nm≦Re(450)−Re(550)≦−3 nm (3″)

50 nm≧Rth(450)−Rth(550)≧3 nm (4″)

[4] The polymer film of any one of [1]-[3], wherein the compound is a merocyanine compound represented by formula (I), and λmax of the compound satisfies 370 nm≦λmax≦400 nm:

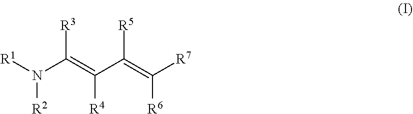

wherein N represents a nitrogen atom; and R¹ to R⁷ each represent a hydrogen atom or a substituent.

[5] The polymer film of [4], wherein in formula (I), R¹ and R² each represent a substituted or unsubstituted alkyl group, and these may bond to each other to form a ring including the nitrogen atom; R⁶ and R⁷ each represent a substituent having a Hammett substituent constant σp of at least 0.2, or R⁶ and R⁷ may bond to each other to form a cyclic active methylene compound structure; and R³, R⁴ and R⁵ are hydrogen atoms.
[6] The polymer film of any one of [1]-[5], wherein the compound is a merocyanine compound represented by formula (Ia):

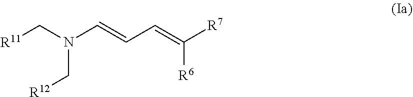

wherein R¹¹ and R¹² each represent an alkyl group, an aryl group, a cyano group or —COOR¹³, or they bond to each other to form a ring containing the nitrogen atom; R⁶ and R⁷ each represent a cyano group, —COOR¹⁴, or —SO₂R₁₅, or they bond to each other to form any of the following cyclic active methylene structures (Ia-1) to (Ia-6); R¹³, R¹⁴ and R¹⁵ each represent an alkyl group, an aryl group, or a heterocyclic group:

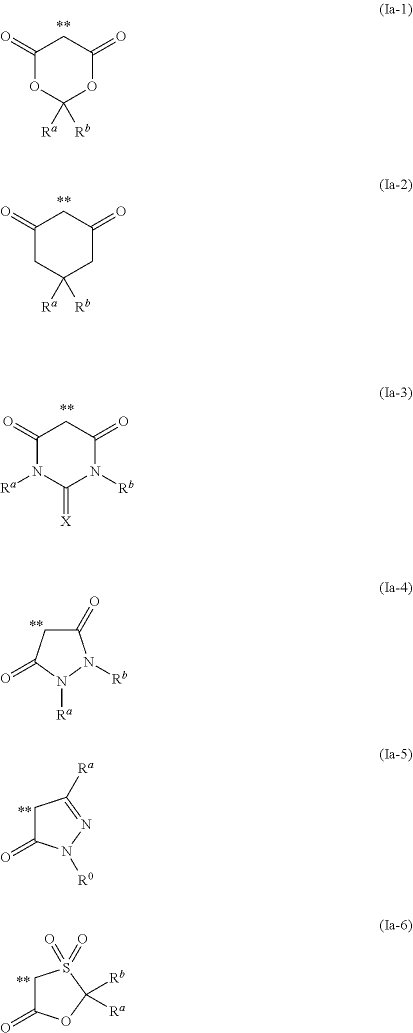

wherein each of “**” indicates the position at which the group bonds to formula (Ia); R^{a} and R^{b} each represent a hydrogen atom, or a C₁-C₂₀ alkyl group; and X represents an oxygen atom or a sulfur atom.

[7] The polymer film of [6], wherein the merocyanine compound represented by formula (Ia) is a compound represented by formula (Ia-a), (Ia-b) or (Ia-c):

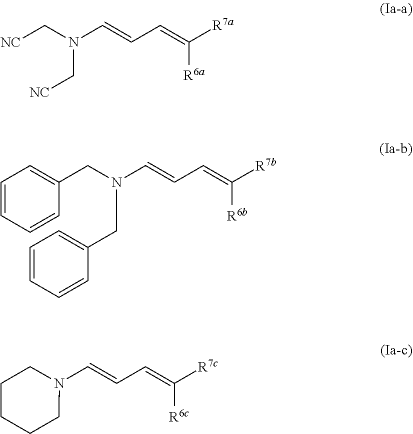

wherein R^{6a} and R^{7a}, R^{6b} and R^{7b}, and R^{6c} and R^{7c} have the same meanings as R⁶ and R⁷, respectively, in formula (Ia).

[8] The polymer film of any one of [1]-[4], wherein the compound is a benzodithiol compound represented by formula (II), and λmax of the compound satisfies 387 nm≦max≦400 nm:

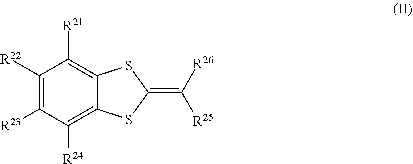

wherein S represents a sulfur atom; R²¹ to R²⁶ each represent a hydrogen atom or a substituent, and if possible, they may bond to each other to form a ring.

[9] The polymer film of any one of [1]-[3] and [8], wherein the compound is a benzodithiol compound represented by formula (IIa):

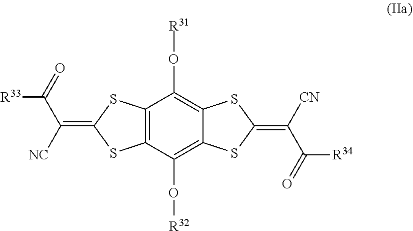

wherein R³¹ and R³² each represent a substituted or unsubstituted alkyl group; R³³ and R³⁴ each represent a substituted or unsubstituted alkyl group, or a substituted or unsubstituted alkoxy group; provided that one CH₂ and two CH₂'s not adjacent to each other in the alkyl group represented by R³¹ to R³⁴ may be replaced by an oxygen atom or a sulfur atom.

[10] The polymer film of any one of [1]-[9], wherein the polymer is a cellulose acylate satisfying formula (10):

2.70<SA+SB≦3.00 (10)

wherein SA represents a degree of substitution with an acetyl group; and SB represents a degree of substitution with any other acyl group than acetyl group.

[11] A method for producing a polymer film of any one of [1]-[10], comprising:

casting a polymer solution that contains at least one polymer of the main ingredient thereof, and at least one compound satisfying relational formulae (1) and (2), in an amount of from 0.2 to 20% by mass of the polymer, to form a web;

stretching the web formed in the casting step, by from 4 to 100% along the machine direction while the residual solvent amount is from 100 to 300% by mass; and, and

drying, after the stretching step, the web at a web surface temperature of from 50 to 100 degrees Celsius while the residual volatile content of the web is from 100 to 10%:

360 nm≦λmax≦400 nm (1)

λ_{1/2}−λmax≦20 nm (2)

wherein λmax indicates the maximum absorption wavelength (unit: nm) of the compound, λ_{1/2} (λmax<λ_{1/2}) indicates the wavelength at which the absorption intensity at λmax is ½.

[12] A retardation film comprising a polymer film of any one of [1]-[10] and, as provided thereon, an optically anisotropic layer formed by curing a liquid-crystal composition.
[13] A polarizing plate comprising a polymer film of any one of [1]-[10] or a retardation film of [12], and a polarizing film, wherein the angle between the in-plane slow axis of the polymer film or the retardation film and the in-plane transmission axis of the polarizing film are parallel to each other.
[14] A liquid-crystal display device at least having a polymer film of any one of [1]-[10].
[15] A TN-mode liquid-crystal display device at least having a retardation film of [12].

### BRIEF DESCRIPTION OF THE DRAWINGS

FIG. 1 is a schematic cross-sectional view of one embodiment of the optically compensatory film of the invention.

FIG. 2 is a schematic cross-sectional view of one embodiment of the polarizing plate of the invention.

FIG. 3 is a schematic cross-sectional view of one embodiment of the liquid-crystal display device of the invention.

In the drawings, the meanings of the reference numerals are as follows:
10 Retardation Film
11 Optically Anisotropic Layer
12 Support (polymer film of the invention)
13 Polarizing Film
14 Protective Film
15 Polarizing Plate
16 Liquid-Crystal Cell
17 TN-Mode Liquid-Crystal Display Device

### DETAILED DESCRIPTION OF THE INVENTION

The invention is described in detail hereinunder. In this description, the numerical range expressed by the wording “a number to another number” means the range that falls between the former number indicating the lowermost limit of the range and the latter number indicating the uppermost limit thereof.

### 1. Polymer Film:

The invention relates to a polymer film comprising at least one polymer as the main ingredient thereof, and at least one compound that satisfies the following relational formulae (1) and (2), in an amount of from 0.2 to 20% by mass of the polymer, of which retardation in plane at a wavelength of λnm, Re(λ), and retardation along the thickness direction at a wavelength of λnm, Rth(λ) satisfy the following formulae (3) and (4). The polymer film of the invention satisfies the following formulae (3) and (4), or that is, its in-plane retardation Re exhibits reversed wavelength dispersion characteristics or is constant irrespective of wavelength in a visible light region, and its thickness-direction retardation Rth exhibits regular wavelength dispersion characteristics or is constant irrespective of wavelength in a visible light region.

360 nm≦λmax≦400 nm (1)

λ_{1/2}−λmax≦20 nm (2)

In the formulae, λmax indicates the maximum absorption wavelength (unit: nm) of the compound, λ_{1/2} (λmax<λ_{1/2}) indicates the wavelength at which the absorption intensity at λmax is ½.

Re(450)−Re(550)≦0 nm (3)

Rth(450)−Rth(550)≧0 nm (4)

A retardation film having reversed wavelength dispersion characteristics of Re and having regular wavelength dispersion characteristics of Rth is useful liquid-crystal display devices employing any mode (for example, TN-mode, VA-mode and IPS-mode). In particular, when used in a TN-mode liquid-crystal display device, the film can improve the viewing angle characteristics of the device. As one method of attaining the optical characteristics, proposed is adding a UV absorbent to a polymer film. However, the UV absorbent causes film coloration (especially yellowing), which is therefore often a bar to the use of the film as a member of display devices. According to the invention, there is provided a polymer film with no coloration and satisfying the above-mentioned characteristics.

Of the polymer film of the invention, Re(450)−Re(550) (hereinafter this may be referred to as “ΔRe”) is equal to or less than 0 nm, and Rth(450)−Rth(550) (hereinafter this may be referred to as “ΔRth”) is equal to or more than 0 nm. ΔRe is preferably at most −3 nm, more preferably at most −5 nm, even more preferably at most −8 nm; and ΔRth is preferably more than 3 nm, more preferably at least 5 nm, even more preferably at least 10 nm. The lowermost limit and the uppermost limit of ΔRe and ΔRth are not specifically defined; however, from the viewpoint of the production aptitude, etc., in general, ΔRe is at least −150 nm or so, and ΔRth is at most 150 nm or so. Specifically, the film satisfies the following formulae (3′) and (4′):

−150 nm≦Re(450)−Re(550)≦0 nm (3′)

150 nm≧Rth(450)−Rth(550)≧0 nm (4′)

Especially in an embodiment of using the film in a TN-mode liquid-crystal display device, the film preferably satisfies the following formulae (3″) and (4″):

−50 nm≦Re(450)−Re(550)≦−3 nm (3″)

50 nm≧Rth(450)−Rth(550)≧3 nm (4″)

Re and Rth of the polymer film of the invention satisfy the following formulae (5) and (6):

60 nm≦Re(550)≦100 nm (5)

40 nm≦Rth(550)≦80 nm (6)

Satisfying the above formulae, the film is suitable for optical compensation and contributes toward enlarging the viewing angle of liquid-crystal display devices, especially TN-mode liquid-crystal display devices. Preferably, Re satisfies the following formula (5′), and also preferably, Rth satisfies the following formula (6′).

70 nm≦Re(550)≦95 nm (5′)

50 nm≦Rth(550)≦75 nm (6′)

The thickness of the polymer film of the invention is not also specifically defined. In an embodiment of using the film as a member of liquid-crystal display devices, in general, the thickness is preferably from 30 to 200 micro meters or so, more preferably from 30 to 100 micro meters or so, even more preferably from 40 to 90 micro meters or so.

Materials and methods usable for production of the polymer film of the invention are described in detail hereinunder.

### 1-(1) Polymer (Main Ingredient):

The polymer film of the invention comprises at least one polymer as the main ingredient thereof. The wording “comprises as the main ingredient” as referred to herein means as follows: When the material of the polymer film is one polymer, the main ingredient is that one polymer; and when the material is comprised of plural types of polymers, then the polymer having the highest content is the main ingredient. The polymer is preferably selected from those having a negative intrinsic birefringence. Preferably, the polymer is a cellulose ester (for example, cellulose triacetate, cellulose acetate propionate, cellulose acetate butyrate, cellulose tripropionate, cellulose diacetate), and is more preferably cellulose triacetate.

The cellulose ester includes cellulose ester compounds, and compounds having an ester-substituted cellulose skeleton that are prepared by biologically or chemically introducing a functional group into a starting material cellulose; and above all, preferred for use herein is a cellulose acylate.

The cellulose ester is an ester of cellulose and acid. The acid to constitute the ester is preferably an organic acid, more preferably a carboxylic acid, even more preferably a fatty acid having from 2 to 22 carbon atoms, most preferably a lower fatty acid having from 2 to 4 carbon atoms.

The cellulose acylate is an ester of cellulose and carboxylic acid. In the cellulose acylate, all or a part of the hydrogen atoms of the hydroxyl groups existing in the 2-position, the 3-position and the 6-position of the glucose units constituting the cellulose are substituted with an acyl group. Examples of the acyl groups include, for example, an acetyl group, a propionyl group, a butyryl group, an isobutyryl group, a pivaloyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, a cyclohexanecarbonyl group, an oleoyl group, a benzoyl group, a naphthylcarbonyl group, and a cinnamoyl group. The acyl group is preferably an acetyl group, a propionyl group, a butyryl group, a dodecanoyl group, an octadecanoyl group, a pivaloyl group, an oleoyl group, a benzoyl group, a naphthylcarbonyl group, a cinnamoyl group, and most preferably an acetyl group, a propionyl group, a butyryl group.

The cellulose ester may be an ester of cellulose and a plurality of acids. The cellulose acylate may be substituted with a plurality of acyl groups.

The degree of substitution with an acetyl group (having 2 carbon atoms) that substitutes for the hydroxyl group of cellulose in the cellulose acylate is represented by SA; and the degree of substitution with any other acyl group than acetyl group (concretely an acyl group having at least 3 carbon atoms) that substitutes for the hydroxyl group of cellulose therein is represented by SB. By controlling SA and SB, the optical properties of the polymer film can be controlled.

The total degree of substitution (total degree of acylation) represented by SA+SB of the cellulose ester for use in the invention is preferably 2.70≦SA+SB≦3.00, more preferably 2.88≦SA+SB≦3.00, even more preferably 2.89≦SA+SB≦2.99, still more preferably 2.90≦SA+SB≦2.98, further more preferably 2.92≦SA+SB≦2.97. Increasing SA+SB could increase Re of the film after heat treatment, therefore enhancing the humidity dependence of retardation of the film. In case where all the hydroxyl groups of the cellulose in the cellulose acylate are substituted with an acyl group, then the total degree of substitution represented by SA+SB is 3.00.

By controlling SB, the humidity dependence of retardation of the cellulose ester film can be controlled. When SB is increased, then the humidity dependence of retardation of the film may be reduced, and the melting point of the film may lower. In consideration of the balance between the humidity dependence of retardation and the melting point depression of the film, the range of SB is preferably 0<SB≦3.0, more preferably 0<SB≦1.0, even more preferably 0.1≦SB≦0.7.

The cellulose ester may be produced according to a known method.

For example, the basic principle of the production method for cellulose acylate is described in Nobuhiko Migita et al's Wood Chemistry, pp. 189-190 (by Kyoritsu Publishing, 1968). One typical production method for cellulose acylate is a liquid-phase acylation method using a carboxylic acid anhydride-carboxylic acid-sulfuric acid catalyst. Concretely, first, a cellulose material such as cotton liner, wood pulp or the like is pretreated with a suitable amount of a carboxylic acid such as acetic acid or the like, and then esterified by put it into an acylation mixture previously cooled, thereby producing a complete cellulose acylate (the total of the degree of acyl substitution at the 2-position, the 3-position and the 6-position is nearly 3.00). The acylation mixture generally comprises a carboxylic acid serving as a solvent, a carboxylic acid anhydride serving as an esterification agent and sulfuric acid serving as a catalyst. In general, the amount of the carboxylic acid anhydride is a stoichiometrically excessive amount over the total of cellulose to react with it and water existing in the system.

Next, after the acylation, for hydrolyzing the excessive carboxylic acid anhydride remaining in the system, water or water-containing acetic acid is added. Further, for partially neutralizing the esterification catalyst, an aqueous solution containing a neutralization agent (for example, carbonate, acetate, hydroxide or oxide of calcium, magnesium, iron, aluminium or zinc) may be added. Further, the obtained complete cellulose acylate is saponified and ripened by keeping it at from 20 to 90 degrees Celsius in the presence of a small amount of acylation catalyst (generally, this is the remaining sulfuric acid), thereby converting it into a cellulose acylate having a desired degree of acylation and a desired degree of polymerization. At the point when the desired cellulose acylate is obtained, the catalyst remaining in the system is completely neutralized with the above-mentioned neutralization agent, or without neutralizing the catalyst, the cellulose acylate solution is put into water or diluted acetic acid (or water or diluted acetic acid may be put into the cellulose acylate solution), whereby the cellulose acylate is separated, washed and stabilized to give the intended product, cellulose acylate.

The degree of polymerization of the cellulose acylate is preferably from 150 to 500 in terms of the viscosity-average degree of polymerization thereof, more preferably from 200 to 400, even more preferably from 220 to 350. The viscosity-average degree of polymerization may be determined according to the Uda et al's limiting viscosity method (Kazuo Uda, Hideo Saito; the Journal of Fiber Science and Technology, Vol. 18, No. 1, pp. 105-120, 1962). The measurement method for the viscosity-average degree of polymerization is described also in JP-A 9-95538.

Cellulose acylate having a small amount of low-molecular components could have a high mean molecular weight (degree of polymerization), but the viscosity thereof may be lower than that of ordinary cellulose acylate. The cellulose acylate having a small amount of low-molecular components may be obtained by removing low-molecular components from the cellulose acylate produced according to an ordinary method. For removing low-molecular components therefrom, the cellulose acylate may be washed with a suitable organic solvent. The cellulose acylate having a small amount of low-molecular components may be obtained through synthesis. In case where the cellulose acylate having a small amount of low-molecular component is produced by synthesis, preferably, the amount of the sulfuric acid catalyst in the acylation is controlled to be from 0.5 to 25 parts by mass relative to 100 parts by mass of cellulose. Controlling the amount of the sulfuric acid catalyst to fall within the range gives a cellulose acylate favorable also in point of the molecular weight distribution (that is, having a uniform molecular weight distribution). The degree or polymerization and the molecular weight distribution of cellulose acylate may be determined through gel permeation chromatography (GPC), etc.

The starting cotton and the production method for cellulose ester are described also in pages 7 to 12 of Hatsumei Kyokai's Disclosure Bulletin (No. 2001-1745, published by Hatsumei Kyokai in Mar. 15, 2001).

The polymer may be powdery or granular, or may also be pellets. Preferably, the water content of the polymer is at most 1.0% by mass, more preferably at most 0.7% by mass, most preferably at most 0.5% by mass. As the case may be, the water content is preferably at most 0.2% by mass. In case where the water content of the polymer does not fall within the preferred range, preferably, the polymer is dried with dry air or by heating before its use herein.

### 1-(2) Wavelength Dispersion Characteristics-Controlling Agent:

The polymer film of the invention contains at least one compound satisfying the following relational formulae (1) and (2), in an amount of from 0.2 to 20% by mass of the polymer constituting the film. The compound serves as a wavelength dispersion characteristics-controlling agent, and contributes toward expressing the optical characteristics satisfying the above-mentioned formulae (3) and (4).

360 nm≦λmax≦400 nm (1)

λ_{1/2}−λmax≦20 nm (2)

wherein λmax indicates the maximum absorption wavelength (unit: nm) of the compound, λ_{1/2} (λmax<λ_{1/2}) indicates the wavelength at which the absorption intensity at λmax is ½.

The present inventors have assiduously studied and, as a result, have found that, when a compound, a type of UV absorbent having λmax satisfying the above formula (1) and has a steep absorption peak satisfying the above formula (2) is added, then a polymer film can be obtained which satisfies the above formulae (3) and (4) and which is free from discoloration (especially free from yellowing), and have completed the present invention. Of those heretofore proposed as a wavelength dispersion characteristics-controlling agent, some compounds have a maximum absorption wavelength λmax in a UV range of less than 360 nm and some other compounds have λmax of more than 400 nm. When the former compounds are used, it is difficult to produce a polymer film satisfying the above formulae (3) and (4) and having Re and Rth each falling within a desired range (for example, having Re of from 60 to 100 nm and having Rth of from 40 to 80 nm); and when the latter compounds are used, the formed polymer film discolors. Further, even when a compound of which the maximum absorption wavelength λmax could satisfy the above formula (1) is used, the obtained polymer film often yellows in case where the absorption peak of the compound is broad. In the present invention, a compound satisfying both the above formulae (1) and (2) is used to give a polymer film that satisfies the above formulae (3) and (4) and is free from discoloration (especially free from yellowing).

λmax does not include the absorption at a wavelength of 300 nm or less (for example, the absorption derived from benzene or naphthalene skeleton).

The type of the compound for use as the wavelength dispersion characteristics-controlling agent in the invention is not specifically defined, and any and every compound satisfying the above formulae (1) and (2) is usable herein.

### Merocyanine Compound:

Examples of the wavelength dispersion characteristics-controlling agent usable in the invention include merocyanine compounds represented by the following general formula (I). Of the merocyanine compounds, those of which λmax satisfies 370 nm≦λmax≦400 nm are preferred. Adding such a merocyanine compound is preferred as more effectively improving the lightfastness of the polymer film, as compared with the polymer film to which a benzodithiol compound to be mentioned below is added. In this description, “lightfastness” means the lightfastness of the polymer film to which the compound is added, and this is determined based on the index that even after the polymer film to which the compound is added is exposed to light with time, its optical characteristics (optical-compensation capability) do not worsen. To that effect, the word “lightfastness” shall be differentiated from the lightfastness of the compound itself. In this description, the word “lightfastness” everywhere has this meaning.

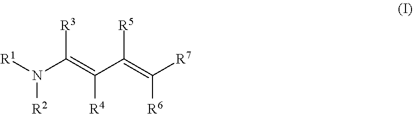

In the formula (I), N represents a nitrogen atom; R¹ to R⁷ each represent a hydrogen atom or a substituent. In the formula (I), preferably, the substituents are so combined that the horizontal direction (right-and-left direction) on the paper corresponds to the long axis direction of the molecule.

Examples of the substituent represented R¹ to R⁷ include a halogen atom (for example, a fluorine atom, a chlorine atom, a bromine atom, an iodine atom), an alkyl group (preferably an alkyl group having from 1 to 30 carbon atoms, more preferably from 1 to 10 carbon atoms, for example, a methyl group, an ethyl group, an n-propyl group, an isopropyl group, a tert-butyl group, an n-octyl group, a 2-ethylhexyl group), a cycloalkyl group (preferably a substituted or unsubstituted cycloalkyl group having from 3 to 30 carbon atoms, more preferably from 3 to 10 carbon atoms, for example, a cyclohexyl group, a cyclopentyl group, a 4-n-dodecylcyclohexyl group), a bicycloalkyl group (preferably a substituted or unsubstituted bicycloalkyl group having from 5 to 30 carbon atoms, more preferably from 5 to 10 carbon atoms, or that is, a monovalent group derived from a bicycloalkane preferably having from 5 to 30 carbon atoms, more preferably from 5 to 10 carbon atoms, by removing one hydrogen atom from it, for example, a bicyclo[1.2.2]heptan-2-yl group, a bicyclo[2.2.2]octan-3-yl group), an alkenyl group (preferably a substituted or unsubstituted alkenyl group having from 2 to 30 carbon atoms, more preferably from 2 to 10 carbon atoms, for example, a vinyl group, an allyl group), a cycloalkenyl group (preferably a substituted or unsubstituted cycloalkenyl group having from 3 to 30 carbon atoms, more preferably from 3 to 10 carbon atoms, of that is, a monovalent group derived from a cycloalkene preferably having from 3 to 30 carbon atoms, more preferably from 3 to 10 carbon atoms, by removing one hydrogen atom from it, for example, a 2-cyclopenten-1-yl group, a 2-cyclohexen-1-yl group), a bicycloalkenyl group (a substituted or unsubstituted bicycloalkenyl group, preferably a substituted or unsubstituted bicycloalkenyl group having from 5 to 30 carbon atoms, more preferably from 5 to 10 carbon atoms, or that is, a monovalent group derived from a bicycloalkene having one double bond, by removing one hydrogen atom from it, for example, a bicyclo[2.2.2]hept-2-en-1-yl group, a bicyclo[2.2.2]oct-2-en-4-yl group), an alkynyl group (preferably a substituted or unsubstituted alkynyl group having from 2 to 30 carbon atoms, more preferably from 2 to 10 carbon atoms, for example, an ethynyl group, a propargyl group), an aryl group (preferably a substituted or unsubstituted aryl group having from 6 to 30 carbon atoms, more preferably from 6 to 10 carbon atoms, for example, a phenyl group, a p-tolyl group, a naphthyl group), a heterocyclic group (preferably a monovalent group derived from a 5- or 6-membered, substituted or unsubstituted, aromatic or non-aromatic heterocyclic compound, by removing one hydrogen atom from it, more preferably a 5- or 6-membered aromatic heterocyclic group having from 3 to 30 carbon atoms, even more preferably having from 3 to 10 carbon atoms, for example, a 2-furyl group, a 2-thienyl group, a 2-pyrimidinyl group, a 2-benzothiazolyl group), a cyano group, a hydroxyl group, a nitro group, a carboxyl group, an alkoxy group (preferably a substituted or unsubstituted alkoxy group having from 1 to 30 carbon atoms, more preferably from 1 to 10 carbon atoms, for example, a methoxy group, an ethoxy group, an isopropoxy group, a tert-butoxy group, an n-octyloxy group, a 2-methoxyethoxy group), an aryloxy group (preferably a substituted or unsubstituted aryloxy group having from 6 to 30 carbon atoms, more preferably from 6 to 10 carbon atoms, for example, a phenoxy group, a 2-methylphenoxy group, a 4-tert-butylphenoxy group, a 3-nitrophenoxy group, a 2-tetradecanoylaminophenoxy group), a silyloxy group (preferably a silyloxy group having from 3 to 20 carbon atoms, more preferably from 3 to 10 carbon atoms, for example, a trimethylsilyloxy group, a tert-butyldimethylsilyloxy group), a heterocyclic-oxy group (preferably a substituted or unsubstituted heterocyclic-oxy group having from 2 to 30 carbon atoms, more preferably from 2 to 10 carbon atoms, for example, a 1-phenyltetrazol-5-oxy group, a 2-tetrahydropyranyloxy group), an acyloxy group (preferably a formyloxy group, a substituted or unsubstituted alkylcarbonyloxy group having from 2 to 30 carbon atoms, more preferably from 2 to 10 carbon atoms, a substituted or unsubstituted arylcarbonyloxy group having from 6 to 30 carbon atoms, more preferably from 6 to 10 carbon atoms, for example, an acetyloxy group, a pivaloyloxy group, a stearoyloxy group, a benzoyloxy group, a p-methoxyphenylcarbonyloxy group), a carbamoyloxy group (preferably a substituted or unsubstituted carbamoyloxy group having from 1 to 30 carbon atoms, more preferably from 1 to 10 carbon atoms, for example, an N,N-dimethylcarbamoyloxy group, an N,N-diethylcarbamoyloxy group, a morpholinocarbonyloxy group, an N,N-di-n-octylaminocarbonyloxy group, an N-n-octylcarbamoyloxy group), an alkoxycarbonyloxy group (preferably a substituted or unsubstituted alkoxycarbonyloxy group having from 2 to 30 carbon atoms, more preferably from 2 to 10 carbon atoms, for example, a methoxycarbonyloxy group, an ethoxycarbonyloxy group, a tert-butoxycarbonyloxy group, an n-octylcarbonyloxy group), an aryloxycarbonyloxy group (preferably a substituted or unsubstituted aryloxycarbonyloxy group having from 7 to 30 carbon atoms, more preferably from 7 to 10 carbon atoms, for example, a phenoxycarbonyloxy group, a p-methoxyphenoxycarbonyloxy group, a p-n-hexadecyloxyphenoxycarbonyloxy group), an amino group (preferably, an amino group, a substituted or unsubstituted alkylamino group having from 1 to 30 carbon atoms, more preferably from 1 to 10 carbon atoms, or a substituted or unsubstituted anilino group having 6 to 30 carbon atoms, more preferably from 6 to 10 carbon atoms, for example, a methylamino group, a dimethylamino group, an anilino group, an N-methylanilino group, a diphenylamino group), an acylamino group (preferably a formylamino group, a substituted or unsubstituted alkylcarbonylamino group having from 1 to 30 carbon atoms, more preferably from 1 to 10 carbon atoms, or a substituted or unsubstituted arylcarbonylamino group having from 6 to 30 carbon atoms, more preferably from 6 to 10 carbon atoms, for example, an acetylamino group, a pivaloylamino group, a lauroylamino group, a benzoylamino group), an aminocarbonylamino group (preferably a substituted or unsubstituted aminocarbonylamino group having from 1 to 30 carbon atoms, more preferably from 1 to 10 carbon atoms, for example, a carbamoylamino group, an N,N-dimethylaminocarbonylamino group, an N,N-diethylaminocarbonylamino group, a morpholinocarbonylamino group), an alkoxycarbonylamino group (preferably a substituted or unsubstituted alkoxycarbonylamino group having from 2 to 30 carbon atoms, more preferably from 2 to 10 carbon atoms, for example, a methoxycarbonylamino group, an ethoxycarbonylamino group, a tert-butoxycarbonylamino group, an n-octadecyloxycarbonylamino group, an N-methyl-methoxycarbonylamino group), an aryloxycarbonylamino group (preferably a substituted or unsubstituted aryloxycarbonylamino group having from 7 to 30 carbon atoms, more preferably from 7 to 10 carbon atoms, for example, a phenoxycarbonylamino group, a p-chlorophenoxycarbonylamino group, an m-n-octyloxyphenoxycarbonylamino group), a sulfamoylamino group (preferably a substituted or unsubstituted sulfamoylamino group having from 0 to 30 carbon atoms, more preferably from 0 to 10 carbon atoms, for example, a sulfamoylamino group, an N,N-dimethylaminosulfonylamino group, an N-n-octylaminosulfonylamino group), an alkyl and arylsulfonylamino group (preferably a substituted or unsubstituted alkylsulfonylamino group having from 1 to 30 carbon atoms, more preferably from 1 to 10 carbon atoms, or a substituted or unsubstituted arylsulfonylamino group having from 6 to 30 carbon atoms, more preferably from 6 to 10 carbon atoms, for example, a methylsulfonylamino group, a butylsulfonylamino group, a phenylsulfonylamino group, a 2,3,5-trichlorophenylsulfonylamino group, a p-methylphenylsulfonylamino group), a mercapto group, an alkylthio group (preferably a substituted or unsubstituted alkylthio group having from 1 to 30 carbon atoms, more preferably from 1 to 10 carbon atoms, for example, a methylthio group, an ethylthio group, an n-hexadecylthio group), an arylthio group (preferably a substituted or unsubstituted arylthio group having from 6 to 30 carbon atoms, more preferably from 6 to 10 carbon atoms, for example, a phenylthio group, a p-chlorophenylthio group, a m-methoxyphenylthio group), a heterocyclic-thio group (preferably a substituted or unsubstituted heterocyclic-thio group having from 2 to 30 carbon atoms, more preferably from 2 to 10 carbon atoms, for example, a 2-benzothiazolylthio group, a 1-phenyltetrazol-5-ylthio group), a sulfamoyl group (preferably a substituted or unsubstituted sulfamoyl group having from 0 to 30 carbon atoms, more preferably from 0 to 10 carbon atoms, for example, an N-ethylsulfamoyl group, an N-(3-dodecyloxypropyl)sulfamoyl group, an N,N-dimethylsulfamoyl group, an N-acetylsulfamoyl group, an N-benzoylsulfamoyl group, an N-(N′-phenylcarbamoyl)sulfamoyl group), a sulfo group, an alkyl and arylsulfinyl group (preferably a substituted or unsubstituted alkylsulfinyl group having from 1 to 30 carbon atoms, more preferably from 1 to 10 carbon atoms, or a substituted or unsubstituted arylsulfinyl group having from 6 to 30 carbon atoms, more preferably from 6 to 10 carbon atoms, for example, a methylsulfinyl group, an ethylsulfinyl group, a phenylsulfonyl group, a p-methylphenylsulfinyl group), an alkyl and arylsulfonyl group (preferably a substituted or unsubstituted alkylsulfonyl group having from 1 to 30 carbon atoms, more preferably from 1 to 10 carbon atoms, or a substituted or unsubstituted arylsulfonyl group having from 6 to 30 carbon atoms, more preferably from 6 to 10 carbon atoms, for example, a methylsulfonyl group, an ethylsulfonyl group, a phenylsulfonyl group, a p-methylphenylsulfonyl group), an acyl group (preferably a formyl group, a substituted or unsubstituted alkylcarbonyl group having from 2 to 30 carbon atoms, more preferably from 2 to 10 carbon atoms, or a substituted or unsubstituted arylcarbonyl group having from 7 to 30 carbon atoms, more preferably from 7 to 10 carbon atoms, for example, an acetyl group, a pivaloyl group, a benzoyl group), an aryloxycarbonyl group (preferably a substituted or unsubstituted aryloxycarbonyl group having from 7 to 30 carbon atoms, more preferably from 7 to 10 carbon atoms, for example, a phenoxycarbonyl group, an o-chlorophenoxycarbonyl group, an m-nitrophenoxycarbonyl group, a p-tert-butylphenoxycarbonyl group), an alkoxycarbonyl group (preferably a substituted or unsubstituted alkoxycarbonyl group having from 2 to 30 carbon atoms, more preferably from 2 to 10 carbon atoms, for example, a methoxycarbonyl group, an ethoxycarbonyl group, a tert-butoxycarbonyl group, an n-octadecyloxycarbonyl group), a carbamoyl group (preferably a substituted or unsubstituted carbamoyl group having from 1 to 30 carbon atoms, more preferably from 1 to 10 carbon atoms, for example, a carbamoyl group, an N-methylcarbamoyl group, an N,N-dimethylcarbamoyl group, an N,N-di-n-octylcarbamoyl group, an N-(methylsulfonyl)carbamoyl group), an aryl and heterocyclic-azo group (preferably a substituted or unsubstituted arylazo group having from 6 to 30 carbon group, more preferably from 6 to 10 carbon atoms, or a substituted or unsubstituted heterocyclic-azo group having from 3 to 30 carbon atoms, more preferably from 3 to 10 carbon atoms, for example, a phenylazo group, a p-chlorophenylazo group, a 5-ethylthio-1,3,4-thiadiazol-2-ylazo group), an imide group (preferably an N-succinimide group, an N-phthalimide group), a phosphino group (preferably a substituted or unsubstituted phosphino group having from 2 to 30 carbon atoms, more preferably from 2 to 10 carbon atoms, for example, a dimethylphosphino group, a diphenylphosphino group, a methylphenoxyphosphino group), a phosphinyl group (preferably a substituted or unsubstituted phosphinyl group having from 2 to 30 carbon atoms, more preferably from 2 to 10 carbon atoms, for example, a phosphinyl group, a dioctyloxyphosphinyl group, a diethoxyphosphinyl group), a phosphinyloxy group (preferably a substituted or unsubstituted phosphinyloxy group having from 2 to 30 carbon atoms, more preferably from 2 to 10 carbon atoms, for example, a diphenoxyphosphinyloxy group, a dioctyloxyphosphinyloxy group), a phosphinylamino group (preferably a substituted or unsubstituted phosphinylamino group having from 2 to 30 carbon atoms, more preferably from 2 to 10 carbon atoms, for example, a dimethoxyphosphinylamino group, a dimethylaminophosphinylamino group), a silyl group (preferably a substituted or unsubstituted silyl group having from 3 to 30 carbon atoms, more preferably from 3 to 10 carbon atoms, for example, a trimethylsilyl group, a tert-butyldimethylsilyl group, a phenyldimethylsilyl group).

Of the above substituents, those having a hydrogen atom may be further substituted with any of the above-mentioned substituents by removing the hydrogen atom. Examples of the functional group are an alkylcarbonylaminosulfonyl group, an arylcarbonylaminosulfonyl group, an alkylsulfonylaminocarbonyl group, an arylsulfonylaminocarbonyl group. Concretely, they include a methylsulfonylaminocarbonyl group, a p-methylphenylsulfonylaminocarbonyl group, an acetylaminosulfonyl group, a benzoylaminosulfonyl group.

In the above formula (I), R¹ and R² each may be a substituted or unsubstituted alkyl group, and R¹ and R² may bond to each other to form a ring including the nitrogen atom; R⁶ and R⁷ each may be a substituent having a Hammett substituent constant σp of at least 0.2, or R⁶ and R⁷ may bond to each other to form a cyclic active methylene compound structure; R³, R⁴ and R⁵ are preferably hydrogen atoms.

The alkyl group to be represented by R¹ and R² is preferably an alkyl group having from 1 to 20 carbon atoms (more preferably from 1 to 10 carbon atoms, even more preferably from 1 to 5 carbon atoms), including, for example, a methyl group, an ethyl group, a propyl group, etc. The alkyl group may be linear or branched. The alkyl group may have a substituent at any position thereof. The substituent includes, for example, a halogen atom (e.g., fluorine atom, chlorine atom, bromine atom, iodine atom), an aryl group (e.g., phenyl, naphthyl), a cyano group, a carboxyl group, an alkoxycarbonyl group (e.g., methoxycarbonyl), an aryloxycarbonyl group (e.g., phenoxycarbonyl), a substituted or unsubstituted carbamoyl group (e.g., carbamoyl, N-phenylcarbamoyl, N,N-dimethylcarbamoyl), an alkylcarbonyl group (e.g., acetyl), an arylcarbonyl group (e.g., benzoyl), a nitro group, a substituted or unsubstituted amino group (e.g., amino, dimethylamino, anilino), an acylamino group (e.g., acetamide, ethoxycarbonylamino), a sulfonamide group (e.g., methanesulfonamide), an imide group (e.g., succinimide, phthalimide), an imino group (e.g., benzylideneamino), a hydroxyl group, an alkoxy group (e.g., methoxy), an aryloxy group (e.g., phenoxy), an acyloxy group (e.g., acetoxy), an alkylsulfonyloxy group (e.g., methanesulfonyloxy), an arylsulfonyloxy group (e.g., benzenesulfonyloxy), a sulfo group, a substituted or unsubstituted sulfamoyl group (e.g., sulfamoyl, N-phenylsulfamoyl), an alkylthio group (e.g., methylthio), an arylthio group (e.g., phenylthio), an alkylsulfonyl group (e.g., methanesulfonyl), an arylsulfonyl group (e.g., benzenesulfonyl), a heterocyclic group (e.g., pyridyl, morpholino), etc. The substituent may be further substituted. In case where the compound has multiple substituents, they may be the same or different, or the substituents may bond to form a ring.

R¹ and R² may bond to each other to form a ring containing the nitrogen atom. The ring is preferably a saturated ring, more preferably a saturated 6-membered ring, even more preferably a piperidine ring.

Preferably, R¹ and R² each are a substituted alkyl group, or an alkyl group substituted with a cyano group, an alkoxycarbonyl group or a phenyl group, or they bond to each other to form a piperidine ring.

R⁶ and R⁷ each may be a substituent having a Hammett substituent constant σp of at least 0.2, or R⁶ and R⁷ may bond to each other to form a ring. The Hammett substituent constant σp is described. The Hammett equation is a rule of thumb proposed by L. P. Hammett in 1935 for qualitatively discussing the influence of a substituent on the reaction or equilibrium of benzene derivatives, and now its reasonability is widely accepted in the art. The substituent constant developed by the Hammett equation includes σp and σm; and these data are found in a large number of general literature. For example, these are described in detail in J. A. Dean “Lange's Handbook of Chemistry”, Ver. 12, 1979 (McGraw-Hill); “Field of Chemistry”, extra edition, No. 122, pp. 96-103, 1979 (Nanko-do); Chem. Rev., 1991, Vol. 91, pp. 165-195, etc. The substituent having a Hammett substituent constant up of at least 0.2 in the present invention is an electron-attractive group. σp of the substituent is preferably at least 0.25, more preferably at least 0.3, even more preferably at least 0.35.

Examples of R⁶ and R⁷ include a cyano group (0.66), a carboxyl group (—COOH: 0.45), an alkoxycarbonyl group (—COOMe: 0.45), an aryloxycarbonyl group (—COOPh: 0.44), a carbamoyl group (—CONH₂: 0.36), an alkylcarbonyl group (—COMe: 0.50), an arylcarbonyl group (—COPh: 0.43), an alkylsulfonyl group (—SO₂Me: 0.72), or an arylsulfonyl group (—SO₂Ph: 0.68), etc. In this description, Me means a methyl group, Ph means a phenyl group. The data in the parenthesis are the σp value of the typical substituent, as extracted from Chem., Rev., 1991, Vol. 91, pp. 165-195.

R⁶ and R⁷ may bond to each other to form a cyclic active methylene compound structure. “Active methylene compound” means a series of compounds each having a methylene group (—CH₂—) sandwiched between two electron-attractive groups. Preferably, the carbon atom to which R⁶ and R⁷ bond is active methylene.

Of the above merocyanine compounds, those of the following general formula (Ia) are preferred.

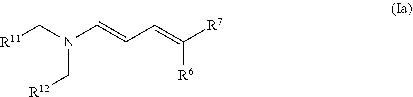

In the formula (Ia), R¹¹ and R¹² each represent an alkyl group, an aryl group, a cyano group or —COOR¹³, or they bond to each other to form a ring containing the nitrogen atom; R⁶ and R⁷ each represent a cyano group, —COOR¹⁴, or —SO₂R₁₅, or they bond to each other to form any of the following cyclic active methylene structures (Ia-1) to (Ia-6); R¹³, R¹⁴ and R¹⁵ each represent an alkyl group, an aryl group, or a heterocyclic group.

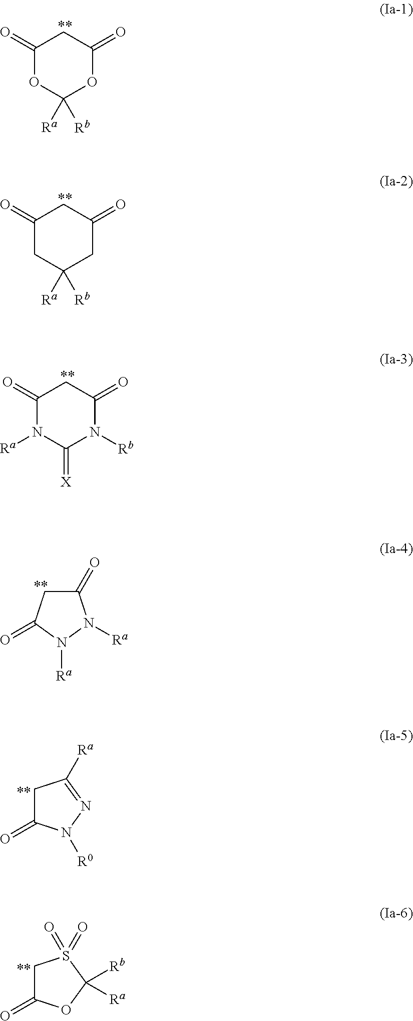

In the formulae, “**” indicates the position at which the group bonds to the formula (Ia); R^{a} and R^{b} each represent a hydrogen atom, or a C₁-C₂₀ (preferably C₁-C₂₀, more preferably C₁C₅) alkyl group; X represents an oxygen atom or a sulfur atom.

The alkyl group to be represented by R¹¹ and R¹² may be unsubstituted or may have a substituent. Examples of the substituent are the same as those of the substituent to be represented by R¹ and R². The alkyl group preferably has from 1 to 20 carbon atoms, more preferably from 1 to 15 carbon atoms, even more preferably from 1 to 6 carbon atoms.

The aryl group to be represented by R¹¹ and R¹² may be unsubstituted or may have a substituent. Examples of the substituent are the same as those of the substituent to be represented by R¹ and R². The aryl group is preferably a phenyl group, more preferably an unsubstituted phenyl group.

In —COOR¹³ to be represented by R¹¹ and R¹², R¹³ is preferably an alkyl group, more preferably an unsubstituted alkyl group. The alkyl group preferably has from 1 to 20 carbon atoms, more preferably from 1 to 15 carbon atoms, even more preferably from 1 to 6 carbon atoms.

The ring to be formed by R¹¹ and R¹² bonding to each other is preferably a saturated ring, more preferably a 6-membered saturated ring, even more preferably a piperidine ring.

Preferably, R¹¹ and R¹² are both a cyano group or an unsubstituted phenyl group, or they bond to each other to form a piperidine group, and even more preferably, the two are both a cyano group or an unsubstituted phenyl group.

In —COOR¹⁴ to be represented by R⁶ and R⁷, R¹⁴ is preferably an alkyl group, more preferably an unsubstituted alkyl group. The alkyl group preferably has from 1 to 20 carbon atoms, more preferably from 5 to 15 carbon atoms.

In —SO₂R₁₅ to be represented by R⁶ and R⁷, R¹⁵ is preferably an aryl group, more preferably a phenyl group.

Of examples of the cyclic active methylene structure to be formed by R⁶ and R⁷ bonding to each other, preferred are those of the formula (Ia-1) or (Ia-4), and more preferred are those of the formula (Ia-1).

Preferably, at least one of R⁶ and R⁷ is a cyano group, or they bond to each other to form any of the above-mentioned, cyclic active methylene structure (Ia-1) to (Ia-6); more preferably, at least one of these is a cyano group, or they bond to each other to form the above-mentioned, cyclic active methylene structure (Ia-1) or (Ia-4); and even more preferably, both the two are a cyano group, or bond to each other to form the above-mentioned, cyclic active methylene structure (Ia-1) or (Ia-4).

Preferred examples of the merocyanine compound of the formula (I) include compounds of the following formulae (Ia-a), (Ia-b) and (Ia-c). More preferred are the compounds of the following formulae (Ia-a) and (Ia-b).

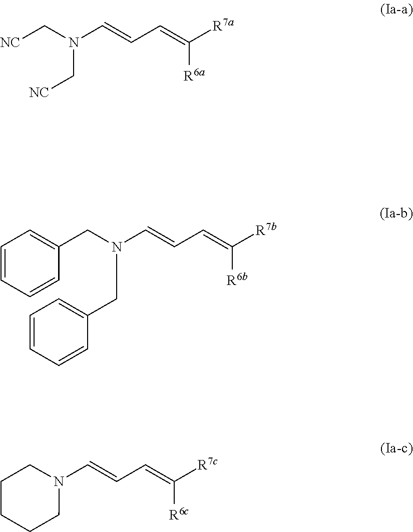

In the formulae, R^{6a} and R^{7a} have the same meanings as R⁶ and R⁷, respectively, and their preferred range is also the same as that of the latter. Above all, compounds in which the substituents form any of the cyclic active methylene structures (Ia-1) to (Ia-6) are preferred from the viewpoint of the ability thereof to prevent discoloration and to secure lighffastness.

In the formulae, R^{6b} and R^{7b} have the same meanings as R⁶ and R⁷, respectively, and their preferred range is also the same as that of the latter. Above all, compounds in which the substituents are both a cyano group, or form any of the cyclic active methylene structures (Ia-1) to (Ia-6) (more preferably, (Ia-1) or (Ia-4), even more preferably (Ia-1)) are preferred from the viewpoint of the ability thereof to prevent discoloration and to secure lighffastness. Especially preferred are the compounds where the two substituents are both a cyano group.

In the formulae, R^{6b} and R^{7b} have the same meanings as R⁶ and R⁷, respectively, and their preferred range is also the same as that of the latter. Above all, compounds in which one of the substituents is a cyano group and the other is —COOR¹⁴ (the definition and the preferred range of R¹⁴ are the same as above), or the substituents form any of the cyclic active methylene structures (Ia-1) to (Ia-6) are preferred.

However, of the compounds of the formula (I), the compound of the following formula does not satisfy the formula (I) as its absorption wavelength is a short wavelength.

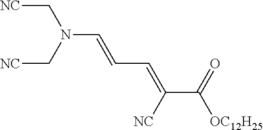

Of the compounds of the above formula (I), those where one of R⁶ and R⁷ is —COOR¹⁴ and the other is —SO₂R¹⁵ could not be effective for enhancing lightfastness.

Examples of the compounds of the formula (I) usable in the invention are shown below, to which, however, the invention is not limited.

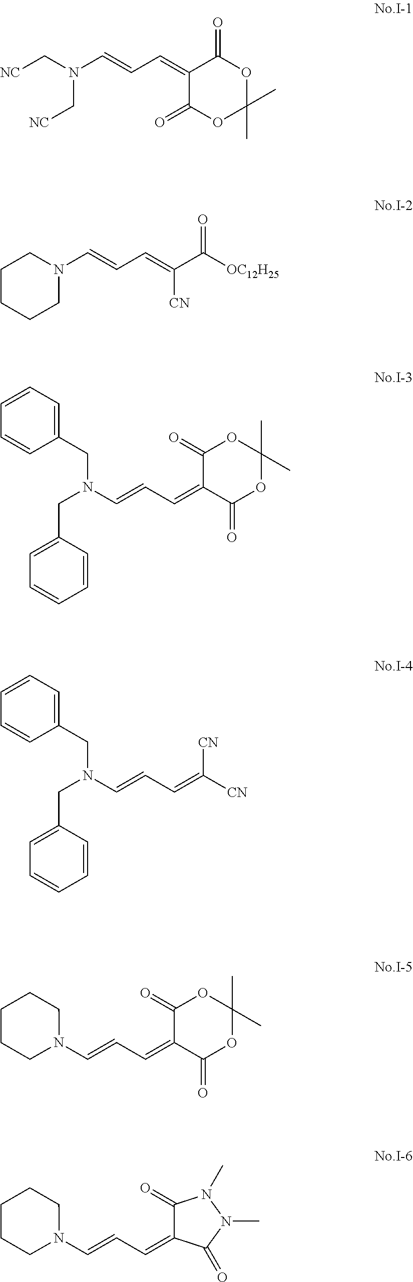

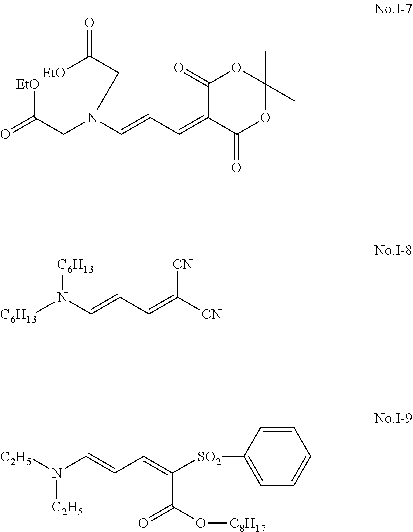

### Benzodithiol Compounds:

Other examples of the wavelength dispersion characteristics-controlling agent usable in the invention include benzodithiol compounds represented by the following general formula (II). Of the benzodithiol compounds, preferred for use herein are those of which λmax satisfies 387 nm≦λmax 400 nm.

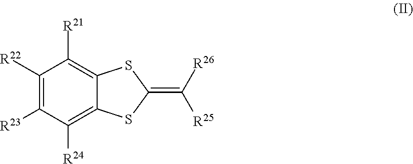

In the formula (II), S represents a sulfur atom; R²¹ to R²⁶ each represent a hydrogen atom or a substituent, and if possible, they may bond to each other to form a ring. In the formula (II), preferably, the substituents are so combined that the horizontal direction (right-and-left direction) on the paper corresponds to the long axis direction of the molecule. Examples of the substituents to be represented by R²¹ to R²⁶ are the same as those to be represented by R¹ to R⁷ in the formula (I).

Preferably, R²² and R²³ bond to each other to form a ring, more preferably, they bond to form a dithiol ring. Preferably, R²⁶ and R²⁵ each are a substituent having a Hammett substituent constant up of at least 0.2; and preferred examples of the substituent are the same as those of the substituent represented by R⁶ and R⁷.

Of the benzodithiol compounds of the formula (II), preferred are those of the following general formula (IIa):

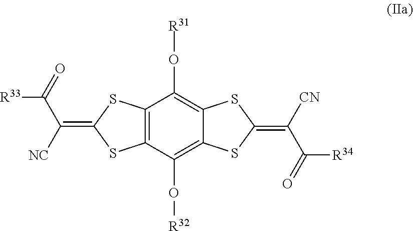

In the formula (IIa), R³¹ and R³² each represent a substituted or unsubstituted alkyl group; R³³ and R³⁴ each represent a substituted or unsubstituted alkyl group, or a substituted or unsubstituted alkoxy group. The substituted or unsubstituted alkyl group, or the alkyl chain in the substituted or unsubstituted alkoxy group to be represented by R³¹ to R³⁴ is preferably a C₁-C₂₀ (preferably C₁-C₁₅, more preferably C₁-C₁₀), substituted or unsubstituted alkyl group. One CH₂ or two or more CH₂'s not adjacent to each other in the alkyl group may be replaced with an oxygen atom or a sulfur atom. The alkyl group and the alkoxy group may have a substituent; and examples of the substituent are the same as those of the substituent to be represented by R¹ to R⁷ in the formula (I). Preferably, the substituent for the alkyl group is an alkoxy group (for example, C₁-C₁₀ alkoxy group). The alkyl group to be represented by R³¹ and R³² may be linear or branched, but are preferably linear from the viewpoint of the wavelength dispersion characteristics-controlling capability of the compound and from the viewpoint of the compound to secure lighffastness. Also preferred are the compounds having an alkoxy substituent at their terminal from the same viewpoint.

Examples of the compounds of the formula (II) usable in the invention are shown below, to which, however, the invention is not limited.

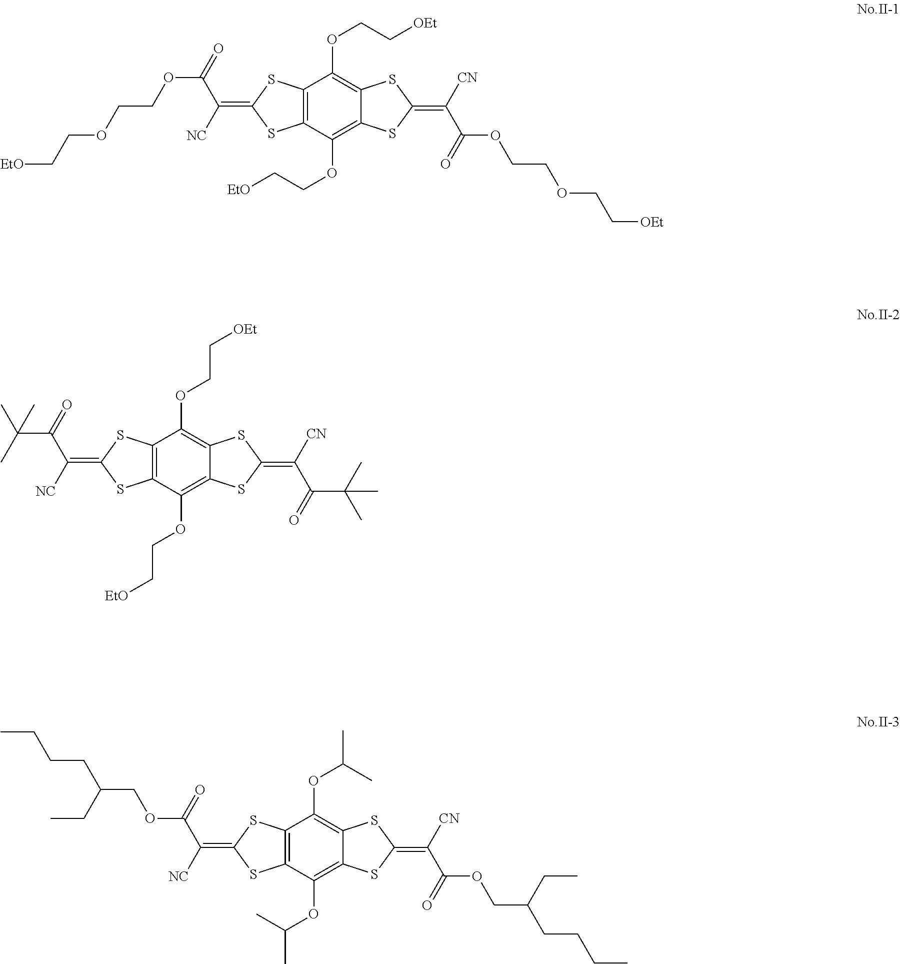

Only one compound satisfying the above formulae (1) and (2) may be added to the polymer film of the invention, or two or more such compounds may be added thereto. The amount to be added is preferably from 0.2 to 20% by mass of the polymer serving as the main ingredient of the film, more preferably from 0.2 to 10% by mass, even more preferably from 0.5 to 5% by mass. Not specifically defined, the molecular weight of the compound satisfying the formulae (1) and (2) is preferably from 100 to 5000 from the viewpoint of the film formability of the polymer composition, more preferably from 150 to 3000, even more preferably from 200 to 2000.

### 1-(3) Other Additives:

The polymer film of the invention may contain any other additive than the compound satisfying the formulae (1) and (2). Examples of the other additives usable in the invention are described below, to which, however, the invention is not limited.

### Long Wavelength Dispersion Characteristics-Controlling Agent:

A compound having an absorption maximum in a wavelength range of from 700 to 1200 nm (long wavelength dispersion characteristics-controlling agent) may be added to the polymer film of the invention. The long wavelength-side, wavelength dispersion characteristics-controlling agent includes, for example, organic compounds such as cyanine compounds, phthalocyanine compounds, naphthalocyanine compounds, polymethine compounds, thiol metal complexes, aminothiophelate metal complexes, immonium compounds, diimmonium compounds, aminium salts, pyrylium compounds, squarylium compounds, pyrrolopyrrole compounds, quaterylene compounds, chroconium compounds, triallylmethane compounds, azulenium compounds, indophenol compounds, anthraquinone compounds, etc.; and inorganic compounds such as aluminium salts, etc.

More specifically, examples of the agent include various compounds described in JP-A-6-256564 and JP-A-2001-208913; phthalocyanines or naphthalocyanines described in JP-A-61-154888, JP-A-61-197281, JP-A-61-246091, JP-A-63-37991, JP-A-63-39388, JP-A-62-233288, JP-A-63-312889, JP-A-2-43269, JP-A-2-138382, JP-A-2-296885, JP-A-3-43461, JP-A-3-77840, JP-A-3-100066, JP-A-3-62878, JP-A-6-214113 and JP-A-10-78509; thiol-series metal complex salts described in JP-A-58-56533, JP-A-62-54143, JP-A-2-4881, JP-A-4-45546, JP-A-2003-221523 and JP-A-2003-327865; aminothioferrate-series metal complex salts described in JP-A-63-112593 and JP-A-2001-89492; di-immonium series compounds described in JP-A-2003-96040 and JP-A-2003-327865; pyrylium-series, squarylium-series or croconium-series compounds described in JP-A-2002-286931 and JP-A-2001-194522; and anthraquinones described in JP-A-61-291651, JP-A-61-291652, JP-A-62-15260, JP-A-62-132963, JP-A-1-129068 and JP-A-1-172458.

Preferable examples of the long wavelength dispersion characteristics-controlling agent, which can be used in the invention, include, but are not limited to, those shown below.

KAYASORB IRG-022 and KAYASORB IRG-040 (NIPPON KAYAKU Co., LTD.); NIR-IM1, NIR-IM2, NIR-IM3 and NIR-IM4 (Nagase ChemteX Corporation); MIR-369 (Yamanoto Chemicals Inc.); IR-301 (YAMADA CHEMICAL CO., LTD.); SDA4428, SDA4927, SDA5688, SDA6104, SDA7611, SDA7775, SDA9800 and SDG7047 (H.W. SANDS); Projet830NP and Projet900NP (Avecia); and IR-1 and IR-2 show below. In formula IR-1, PTS⁻ represents para-toluene sulfonate ion.

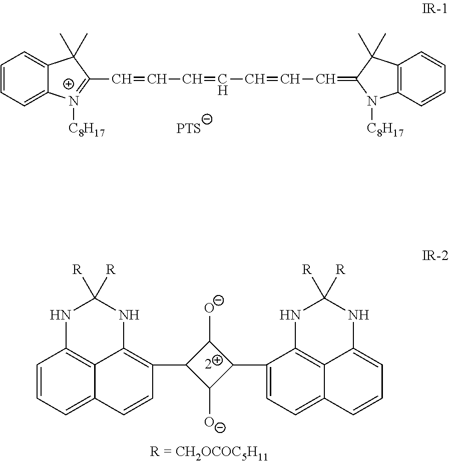

The amount of the long wavelength-side, long wavelength dispersion characteristics-controlling agent to be added is preferably from 0.001 to 2% by mass or so of the main ingredient polymer, more preferably from 0.002 to 1% by mass or so, even more preferably from 0.01 to 0.5% by mass or so.

The molecular weight of the long wavelength-side, long wavelength dispersion characteristics-controlling agent is preferably from 100 to 5000, more preferably from 150 to 3000, even more preferably from 200 to 2000.

### Plasticizer, Optical Anisotropy-Controlling Agent:

A plasticizer (its preferred amount to be added is from 0.01 to 10% by mass of the main ingredient polymer—the same shall apply hereinunder) and/or an optical anisotropy-controlling agent (0.01 to 10% by mass) may be added to the polymer film of the invention. Preferably, the plasticizer and the optical anisotropy-controlling agent are organic compounds having a molecular weight of at most 3000, more preferably they are selected from compounds having both a hydrophobic moiety and a hydrophilic moiety. These compounds are aligned among the polymer chains to thereby change retardation of the polymer film. Further, in case where a cellulose acylate is used as the main ingredient of the polymer film, the compounds act to enhance the hydrophobicity of the film and to reduce the humidity-dependent change of retardation of the film.

As the plasticizer and the optical anisotropy-controlling agent, concretely, preferred are compounds having at least one aromatic ring, more preferably having from 2 to 15 aromatic rings, even more preferably having from 3 to 10 aromatic rings. Preferably, the other atoms than those of the aromatic ring in the compound are configured nearly in the same plane as that of the aromatic ring; and in case where the compound has multiple aromatic rings, also preferably, the multiple aromatic rings therein are configured nearly in the same plane. For selectively increasing Rth of the polymer film, the real state of the additive in the film is preferably so controlled that the plane of the aromatic ring in the additive compound could be parallel to the film plane.

One additive or two or more additives may be used either singly or as combined for the plasticizer and the optical anisotropy-controlling agent. For the plasticizer or the optical anisotropy-controlling agent having the ability to increase Rth of the polymer film, concretely mentioned are the plasticizers described on pages 33 and 34 of JP-A 2005-104148, and the optical anisotropy-controlling agents described on pages 38 and 39 of JP-A 2005-104148.

### Stabilizer:

The stabilizer (its preferred amount to be added is from 0.0001 to 1% by mass) is added to the polymer film for the purpose of preventing the polymer from discoloring or thermally degrading in film formation. The stabilizer is a compound having the ability to prevent the polymer itself from decomposing and denaturing, and is selected from antioxidant, radical inhibitor, peroxide decomposing agent, Metal inactivator, acid scavenger, and light stabilizer. In the invention, any of these stabilizers are employable. Of those stabilizers, preferred for use in the invention are antioxidant and radical inhibitor, and more preferred is antioxidant.

As the antioxidant, preferred are phosphorous acid skeleton-having phosphoric acid compounds, thioether structure-having sulfur compounds, pentaerythritol skeleton structure-having phosphate compounds, lactone structure-having lactone compounds; and as the radical inhibitor, preferred are hydroxyl group-substituted aromatic ring-having phenolic compounds, substituted or unsubstituted amino group-having amine compounds; as the peroxide decomposing agent, preferred are phenolic compounds, amine compounds; as the metal inactivator, preferred are amide bond-having amide compounds; as the acid scavenger, preferred are epoxy group-having epoxy compounds; and as the light stabilizer, preferred are amine compounds.

One or more different types of those stabilizers may be used here either singly or as combined; or compounds having two or more different functions in one molecule are also usable here.

Preferably, the volatility of the stabilizer is fully low at high temperatures. Preferably, at least one stabilizer having a molecular weight of at least 500 is in the polymer film. More preferably, the molecular weight of the stabilizer is from 500 to 4000, even more preferably from 530 to 3500, still more preferably from 550 to 3000. Having a molecular weight of at least 500, the thermal volatility of the compound could be well low; and having a molecular weight of at most 4000, the miscibility of the compound with cellulose acylate is good.

As the stabilizer, herein usable are commercial products. For example, preferred for use herein are pentaerythritol skeleton structure-having phosphate antioxidants such as cyclic neopentanetetraylbis(2,6-di-t-butyl-4-methylphenyl) phosphite (ADEKA's “Adekastab PEP-36”), etc.

In addition, the polymer film of the invention may contain at least one of fine particle powder having a mean particle size of from 5 to 3000 nm (0.001 to 1% by mass), fluorosurfactant (0.001 to 1% by mass) and release agent (0.0001 to 1% by mass). These additives may be added as a liquid or a solid in the film production process. Preferably, the additives for use in the invention are substantially nonvolatile in the drying step in film production. One or more different types of these additives may be used here either singly or as combined.

### 1-(4) Production Method for Polymer Film:

The production method for the polymer film of the invention is not specifically defined. The polymer film may be produced in various film formation methods such as a solution casting method, a melt casting method, etc.

In the solution casting method, for example, a polymer solution comprising the above-mentioned polymer, the compound satisfying the formulae (1) and (2) and optionally other various additives is used for film formation.

In the melt casting method, a melt prepared by heating a polymer composition that comprises the polymer, the compound satisfying the formulae (1) and (2) and optionally other various additives is cast onto a support and cooled to form a film thereon. In case where the melting point of the polymer, or the melting point of the mixture of the polymer and other various additives is lower than the decomposition point of those ingredients and is higher than the stretching temperature of the formed film, then the melt casting method is employable. The melt casting method is described in, for example, JP-A 2000-352620.

For stably producing the film satisfying the above formulae (3) to (6), preferably, a solution casting method is employed and the film is formed through the following wet-stretching and crystallization step. One example of the production method for the polymer film of the invention according to the solution casting method comprises the following steps:

A casting step of casting a polymer solution that contains at least one polymer of the main ingredient thereof, and at least one compound satisfying the above-mentioned relational formulae (1) and (2) in an amount of from 0.2 to 20% by mass of the polymer, to form a web;

A stretching step of stretching the web formed in the casting step, by from 4 to 100% along the machine direction while the residual solvent amount is from 100 to 300% by mass; and,

A drying step of drying, after the stretching step, the web at a web surface temperature of from 50 to 100 degrees Celsius while the residual volatile content of the web is from 100 to 10%.

According to the method, the polymer film satisfying the above-formulae (3) and (4) and capable of fully expressing Re and Rth can be stably produced.

The process of the solution casting method is described concretely hereinunder. In the following example, cellulose acylate is used as the main polymer ingredient.

### (Preparation of Polymer Solution)

In the invention, the polymer solution may be prepared, for example, according to the methods described in JP-A 58-127737, 61-106628, 2-276830, 4-259511, 5-163301, 9-95544, 10-45950, 10-95854, 11-71463, 11-302388, 11-322946, 11-322947, 11-323017, 2000-53784, 2000-273184, 2000-273239. Concretely, a polymer and a solvent are mixed, stirred and swollen, and optionally cooled or heated to prepare a mixture, and this is filtered to give the polymer solution for use in the invention.

In the invention, for increasing the solubility of the polymer in the solvent used, preferably, the film production method includes a step of cooling and/or heating the mixture of polymer and solvent.

In case where a halogen-containing organic solvent is used and when the mixture of cellulose acylate and the solvent is cooled, preferably, the production method includes a step of cooling the mixture to −100 to 10 degrees Celsius. More preferably, the method includes a step of swelling the system at −10 to 39 degrees Celsius prior to the cooling step, and a step of heating the system at 0 to 39 degrees Celsius after the cooling step.

In case where a halogen-containing organic solvent is used and when the mixture of cellulose acetate and the solvent is heated, preferably, the production method includes a step of dissolving the cellulose acylate in the solvent according to at least one method selected from the following (a) and (b).

(a) Swelling the system at −10 to 39 degrees Celsius and heating the resulting mixture at 0 to 39 degrees Celsius.

(b) Swelling the system at −10 to 39 degrees Celsius, then heating the resulting mixture at 40 to 240 degrees Celsius under 0.2 to 30 MPa, and cooling the heated mixture at 0 to 39 degrees Celsius.

In case where a halogen-free organic solvent is used and when the mixture of cellulose acylate and the solvent is cooled, the production method preferably includes a step of cooling the mixture at −100 to −10 degrees Celsius. Also preferably, the production method includes a step of swelling the system at −10 to 55 degrees Celsius prior to the cooling step, and includes a step of heating the system at 0 to 57 degrees Celsius after the cooling step.

In case where a halogen-containing organic solvent is used and when the mixture of cellulose acylate and the solvent is heated, preferably, the production method includes a step of dissolving the cellulose acylate in the solvent according to at least one method selected from the following (c) and (d).

(c) Swelling the system at −10 to 55 degrees Celsius and heating the resulting mixture at 0 to 57 degrees Celsius.

(d) Swelling the system at −10 to 55 degrees Celsius, then heating the resulting mixture at 40 to 240 degrees Celsius under 0.2 to 30 MPa, and cooling the heated mixture at 0 to 57 degrees Celsius.

### (Web Formation)

In the invention, a web may be formed according to the solution casting method of using the polymer solution of the invention. In carrying out the solution casting method, any known apparatus can be used according to conventional methods. Concretely, a dope (polymer solution in the invention) prepared in a dissolver (vessel) is filtered, then once stored in a reservoir and defoamed to be a final dope. The dope is kept at 30 degrees Celsius, and through the dope discharging port, this is fed to a pressure die via a pressure metering gear pump capable of feeding the dope with high accuracy, for example, based on the rotation speed thereof, and the dope is uniformly cast onto the endlessly-running metal support of a casting zone through the slit of the pressure die (dope casting step). Next, at the peel point at which the metal support runs nearly one full circle, the wet dope film (web) is peeled from the metal support, then conveyed into a drying zone, in which the film is dried while conveyed by rolls. The details of the casting step and the drying step of the solution casting method are described in JP-A 2005-104148, pp. 120-146, which may be suitably incorporated in the invention by reference.

In the invention, a metal band or a metal drum may be used as the metal support in web formation.

### (Wet Stretching Step)

In the production method for cellulose acylate film of the invention, the web formed in the casting step is, while conveyed, stretched in the machine direction in the stretching step. In this step, the residual solvent amount at the start of stretching the web is from 100 to 300% by mass. Specifically, in the production of the polymer film of the invention, the web is stretched in a mode of wet stretching while the residual solvent amount therein is large.

The residual solvent amount in the cellulose acylate web at the start of wet stretching may be computed according to the following formula.

Residual Solvent Amount(% by mass)={(M−N)/N}×100

wherein M indicates the mass of the cellulose acylate film just before introduced into the stretching zone; N indicates the mass of the cellulose acylate film just before introduced into the stretching zone and after dried at 120 degrees Celsius for 2 hours.

In the wet stretching step, the residual solvent amount in the wet at the start of stretching it is from 150 to 300% by mass, and in consideration of the balance of the condition of the web to be peeled, the stretching temperature and the stretching ratio in stretching, the residual solvent amount is preferably from 200 to 300% by mass. When the residual solvent amount is less than 150% by mass, the web being stretched may be broken at a low stretching temperature. Accordingly, the stretching temperature must be high and, if so, the energy efficiency mow lower. Even when the stretching temperature is made high, the web may also be broken When stretched at a high stretching ratio. Further, when the residual solvent amount is less than 100% by mass, the film may be hard and could hardly be stretched, and therefore the film could not have the desired optical properties. When the residual solvent amount is more than 300% by mass, then the web peelability and the web stretchability (handlability not causing wrinkles), and the web recovery may greatly lower. In particular, when the residual solvent amount is within a range of from 200 to 300% by mass, then the stretching ratio in stretching is easy to increase and the web is more effectively prevented from being cut or broken.

The residual solvent amount in the cellulose acylate web may be suitably controlled by changing the concentration of the polymer solution used, the temperature and the speed of the metal support, the temperature and the airflow of the drying air, and the solvent gas concentration in the drying atmosphere, etc.

In the wet stretching step, the web is stretched in the machine direction while conveyed. The stretching ratio of the web is preferably from 5 to 100%, more preferably from 15 to 50%, from the viewpoint of preventing the web from being cut or broken while attaining the high stretching ratio. The stretching ratio (elongation) of the cellulose acylate web in the stretching step may be attained by the peripheral speed difference between the metal support speed and the peeling speed (peeling roll draw). For example, in case where an apparatus having two nip rolls is used, the rotation speed of the nip roll on the inlet port side is made higher than the rotation speed of the nip roll on the outlet port side, whereby the cellulose acylate film can be favorably stretched in the machine direction (lengthwise direction). Through the stretching, retardation expressibility of the film can be controlled.

“Stretching ratio (%)” as referred to herein is determined according to the following formula:

Stretching ratio(%)=100×{(length after stretching)−(length before stretching)}/(length before stretching)

In the wet stretching step, the surface temperature (stretching temperature) of the web being stretched is not specifically defined. From the viewpoint of securing the stretching efficiency and reducing the volatile change, the temperature is preferably 30 degrees Celsius or lower. The stretching speed for the web in the stretching step is not also specifically defined. From the viewpoint of the stretching aptitude (handlability with no wrinkles), the stretching speed is preferably from 1 to 1000%/min, more preferably from 1 to 100%/min. The stretching may be attained in one stage or may be attained in multiple stages. In addition, the web being stretched may be stretched additionally in the direction vertical to the machine direction (cross direction).

After the wet stretching step, the web is subsequently transferred to a drying (crystallization) step. In the drying step, the web is dried while its both sides are clipped or pinned.

### (Drying (Crystallization) Step)

After thus wet-stretched in the previous step, the web is subsequently dried (for crystallization). At the start of the drying step, the residual volatile content in the web is from 10 to 100% by mass, preferably from 20 to 100% by mass, and the mean surface temperature is from 30 to 100 degrees Celsius.

Satisfying the above-mentioned specific condition, the movement of the molecules in the cast web is sufficiently though at a low temperature, and the amount of the molecules that may interfere with crystallization is sufficiently small and is enough for crystallization; and therefore, under the condition, the crystallization of the web goes on efficiently even at a low temperature. In case where the volatile content is more than the above range, the molecular movement may be sufficient but there exist a large number of molecules to interfere with the crystallization, and therefore the crystallization of the web could not go on. When the volatile content is smaller than the above range, a sufficient molecular movement could not be attained at a low temperature. When the surface temperature is lower than the above range, the molecular movement would be insufficient; but when higher than the range, then the molecular movement would be too active and the crystallization could not go on.

Preferably, the crystallization treatment is attained while the cellulose acylate film (web) is conveyed. The method of conveying the cellulose acylate film is not specifically defined. Typically, the film may be conveyed by nip rolls or suction drums, or may be conveyed by tenter clips (by which the film is floated and conveyed under air pressure). Preferred are a method of conveying the film by fixing it with a pin tenter, and a method of conveying the film by multiple conveyor rollers as spaced narrowly from the adjacent ones. More preferred is a method of conveying the film by fixing it with a pin tenter.

Concretely, in the method of conveying the film by fixing it with a pin tenter, both sides of the cellulose acylate film on the line perpendicular to the machine direction are fixed with a pin tenter, and the film is conveyed while the distance between the tenter of fixing one side and the tenter of fixing the other side is controlled. The distance between the tenters can be controlled by suitably defining the tenter rail pattern. By controlling the distance between the tenters in that manner, the cellulose acylate film can be dried while the dimensional change in the cross direction thereof is controlled to be a desired level.

For preventing the web from being broken or wrinkled or for preventing the conveyance failure of the web, preferably, the pin density inside the pin tenter is made high and the pin density outside the pin tenter is made low.

In the method of conveying by multiple conveyor rollers narrowly spaced from each other, concretely, a cellulose acylate film may be introduced into multiple conveyor roller arranged inside the crystallization zone in such a manner that the distance between the adjacent conveyor rollers could be from 0.1 cm to 50 cm, and may be conveyed by those rollers. The distance between the adjacent conveyor rollers indicates the distance for which the film being conveyed separates from one conveyor roller and reaches and wraps around the next conveyor roller. By introducing the film into a group of conveyor rollers as spaced from each other by such a narrow distance (so-called dense rolls), the holding force by the conveyor rollers acts on the cross direction of the film, and the dimensional change in the cross direction of the film can be thereby controlled. According to this method, expansion in the cross direction as in the tenter clip method is impossible, but the shrinkage could be minimized.

The conveyance speed is generally from 1 to 500 m/min, preferably from 5 to 300 m/min, more preferably from 10 to 200 m/min, even more preferably from 20 to 100 m/min. When the conveyance speed is not lower than the lowermost limit, 1 m/min, the method is industrially favorable as securing sufficient producibility; and when not higher than the uppermost limit, 500 m/min, the method is also favorable since the crystal growth could be fully attained in a practicable crystallization zone length. When the conveyance speed is increased, the film discoloration could be prevented, and when the conveyance speed is decreased, the crystallization zone length could be reduced. Preferably, the conveyance speed during crystallization (driving speed of nip rolls, suction drums and others to determine the conveyance speed) is kept constant.

For preventing the web itself from foaming and for preventing the web from adhering to the holding means inside the tenter, preferably, the pins for holding both edges of the web are cooled to a temperature lower than the web foaming temperature by a blow-type cooling unit, and the pins just before catching the web are cooled to be not higher than 0 degrees Celsius of the dope in a duct-type cooling unit, in the tenter drying apparatus.

The crystallization method includes, for example, a method of conveying the cellulose acylate film through a zone at a temperature T; a method of applying hot air to the cellulose acylate film being conveyed; a method of irradiating the cellulose acylate film being conveyed with heat rays; a method of contacting the cellulose acylate film with a heated roll, etc.

Preferred is the method where the cellulose acylate film being conveyed is led to pass through a zone at a temperature T with applying hot air thereto. The method has an advantage in that the cellulose acylate film can be uniformly heated. The temperature inside the zone is kept at a predetermined constant temperature T, for example, by monitoring it with a temperature sensor and by heating the zone with a heater. The conveyance length of the cellulose acylate film in the zone at a temperature T may vary depending on the property of the cellulose acylate film to be produced and on the conveyance speed thereof, and in general, the length is preferably so designed that the ratio of (conveyance length)/(width of the cellulose acylate film to be conveyed) could be from 0.1 to 100, more preferably from 0.5 to 50, even more preferably from 1 to 20. In this description, the ratio may be referred to as the aspect ratio. The time to be taken by the film to pass through the zone at a temperature T (time for crystallization) is generally from 0.01 to 60 minutes, preferably from 0.03 to 10 minutes, more preferably from 0.05 to 5 minutes. Falling within the range, the film enjoys excellent retardation expression and is prevented from discoloring.

For preventing the quality loss such as planarity loss in increasing the speed in a solution casting method or in increasing the width of the web in a tenter, there is disclosed an invention in which the air speed is defined to be from 0.5 to 20 (40) m/sec, the lateral direction temperature distribution is defined to be within 10%, and the air volume ratio on and below the web is defined to be from 0.2 to 1 in drying the web in a tenter.

Preferably, the web is dried with a drying gas that blows out in such a manner, as based on the uppermost limit of the wind speed in the wind speed distribution on the surface of the film positioned in the drying gas blow extending direction, that the difference between the uppermost limit and the lowermost limit is within 20%.

In the production method of the invention, the film may be stretched or shrunk in the direction vertical to the machine direction while the volatile content in the film is from 300 to 10% for the purpose of controlling Re and/or Rth of the film. For reducing Re and for increasing Rth, the film is preferably stretched; while on the other hand, for increasing Re and for reducing Rth, the film is preferably shrunk.

By stretching the cellulose acylate film in the direction perpendicular to the machine direction during crystallization thereof, the film properties in the slow axis direction may be regulated (uniformized) and the film surface condition may be bettered.

For example, the cellulose acylate film may be led to pass through a heating zone while both sides thereof are fixed with a pin tenter and while the film is thus stretched or shrunk in the direction perpendicular to the machine direction (lateral direction).

The stretching ratio of the film in the direction perpendicular to the machine direction may be generally from 0.8 to 10 times, preferably from 1.0 to 5 times, more preferably from 1.1 to 3 times. The stretching speed is preferably from 20 to 10000%/min, more preferably from 40 to 1000%/min, even more preferably from 50 to 500%/min.

When the film is shrunk, the degree of shrinkage is preferably from 5 to 80%, more preferably from 10 to 70%, even more preferably from 20 to 60%, most preferably from 25 to 50%. The degree of shrinkage in the lateral direction may be computed according to the following formula, by measuring the overall width of the film before and after shrinkage.

Degree of shrinkage in lateral direction(%)=100×(overall width before shrinkage−overall width after shrinkage)/overall width before shrinkage

In the production method of the invention, the crystallization treatment may be effected only once, or may be effected multiple times. “Effecting the crystallization treatment multiple times” means that after the previous crystallization treatment, the film is again set at a temperature higher than Tc and lower than Tm₀, and while the film is conveyed in the condition, the film is again crystallized. In case where the film is crystallized multiple times, preferably, the stretching ratio of the film satisfies the above range at the stage after all the crystallization treatments. In the production method of the invention, preferably, the crystallization treatment is attained at most three times, more preferably at most two times, but most preferably once.

In the above, the method for producing the polymer film of the invention is described, which comprises a step of solution casting to form a web followed by a step of wet stretching the web containing a large quantity of residual solvent, and a step of drying (crystallization) the resulting film. According to the method, the polymer film satisfying the above formulae (3) to (6) can be produced stably. However, by selecting the additives to be used, the polymer film satisfying the above formulae (3) to (6) can also be produced. For example, according to a method comprising drying the web formed by solution casting, then dry stretching the web containing little residual solvent, and thereafter heating it, the polymer film satisfying the above formulae (3) to (6) can also be produced.

### (Multilayer Casting)

A cellulose acylate solution may be cast onto a smooth band or drum serving as a metal support, as a single layer liquid thereon, or multiple cellulose acylate solutions for two or more layers may be cast thereon. In case where Multiple cellulose acylate solutions are cast, a cellulose acylate-containing solution may be cast through multiple casting ports arranged at intervals in the machine direction of the metal support, thereby forming multiple layers to constitute a film. For example, the methods described in JP-A 61-158414, 1-122419, 11-198285 are employable here.

A cellulose acylate solution may be cast through two casting ports for film formation. For example, this may be attained according to the methods described in JP-B 60-27562, JP-A 61-94724, 61-947245, 61-104813, 61-158413, 6-134933. Also employable herein is a cellulose acylate film casting method of enveloping the flow of a high-viscosity cellulose acylate solution with a low-viscosity cellulose acylate solution, and simultaneously extruding the high-viscosity and low-viscosity cellulose acylate solutions, as in JP-A 56-162617. An embodiment where the outside solution contains a larger amount of an alcohol component of a poor solvent than the inside solution is also preferred, as in JP-A 61-94724 and 61-94725. Another method is also employable where, using two casting ports, a film is formed on a metal support through the first casting port, then the film is peeled, and on the side of the film having contacted with the metal support, another solution is cast through the second casting port to form a film thereon, for example, as in JP-B 44-20235. Not specifically defined, the cellulose acylate solutions to be cast may be the same solution or may be different cellulose acylate solutions. For making multiple cellulose acylate layers have respective functions, the cellulose acylate solutions corresponding to the functions may be extruded out through the respective casting ports. The cellulose acylate solution may be co-cast along with any other functional layers (for example, adhesive layer, dye layer, antistatic layer, antihalation layer, UV absorbent layer, polarization layer).

A conventional single-layer liquid requires extrusion of a high-concentration high-viscosity cellulose acylate solution for attaining the necessary film thickness, which, however, is often problematic in that the cellulose acylate solution is poorly stable and often forms solid to cause spot failures, and the smoothness of the film is poor. To solve the problem, multiple cellulose acylate solutions are cast through casting ports to thereby simultaneously extrude high-viscosity solutions onto a metal support. Accordingly, a film having a bettered and excellent surface condition can be formed, and in addition, using such a thick cellulose acylate solution reduces the drying load and promotes the film production speed.

In co-casting, the outer thickness and the inner thickness are not specifically defined, but preferably, the outer thickness is from 1 to 50%, more preferably from 2 to 30% of the overall thickness. In three or more multiple layer co-casting, the total thickness of the layer contacted with the metal support and the layer on the air side is defined as the outer thickness. In co-casting, cellulose acylate solutions differing from each other in the additive concentration of plasticizer, UV absorbent, mat agent or the like may be co-cast to form a multilayered cellulose acylate film. For example, a cellulose acylate film having a constitution of skin layer/core layer/skin layer may be formed. For example, the mat agent may be added more to the skin layer, or may be added to only the skin layer. The plasticizer and the UV absorbent may be added more to the core layer than to the skin layer, or may be added to only the core layer. The type of the plasticizer and the UV absorbent may be changed between the core layer and the skin layer. For example, a low-volatile plasticizer and/or UV absorbent may be added to the skin layer, and a more potent plasticizer or UV absorbent may be added to the core layer. A release promoter may be added to only the skin layer on the metal support side, and this is a preferred embodiment. For cooling the metal support to gel the solution by a chill drum method, preferably, a poor solvent alcohol may be added more to the skin layer than to the core layer. The skin layer and the core layer may differ in Tg; and preferably, Tg of the core layer is lower than Tg of the skin layer. The skin layer and the core layer may also differ in the viscosity of the cellulose acylate-containing solution to be cast for forming the layer; and preferably, the viscosity of the skin layer is smaller than the viscosity of the core layer, however, the viscosity of the core layer may be smaller than the viscosity of the skin layer.

(Stretching while the Volatile Content is from 10% to 0%)

In the production method of the invention, the cellulose acylate film may be stretched after the crystallization treatment. In this stage, the film may be stretched in TD (direction perpendicular to the machine direction), whereby the humidity dependence of retardation (especially Re) of the finally obtained transparent film could be effectively reduced. The volatile content in the film being stretched is from 10 to 0%, and the temperature thereof is preferably from 60 to 200 degrees Celsius, more preferably from 90 to 140 degrees Celsius. When the temperature is lower than 90 degrees Celsius, then the stretching would be insufficient; but when higher than 200 degrees Celsius, there occurs other problems of bleeding or vaporization.

TD stretching is considered to reduce the aligned amorphous part not greatly moving the crystal part. Accordingly, TD stretching makes it possible to reduce the humidity dependence of Re not greatly changing Re, and makes it possible to control the wavelength dispersion characteristics of Re. Preferably, TD stretching is attained in the direction perpendicular to the machine direction from the viewpoint of efficiently reducing the aligned amorphous part.

Stretching after heat treatment improves the humidity dependence of the obtained film and regulates the wavelength dispersion characteristics of retardation of the film. The humidity dependence and the wavelength dispersion characteristics of retardation of film are determined mainly by the alignment of the amorphous part and the additive (wavelength dispersion characteristics-controlling agent). On the other hand, the direction of the slow axis of film and the absolute value of Re and Rth thereof are determined mainly by the alignment of the crystal part. Now, the alignment direction of the film before stretching is investigated. In the film processed for crystallization alone, the crystal part, the amorphous part and the additive are aligned in the machine direction in the process of crystallization. The invention is characterized in that the film after the crystallization step is stretched within the above-mentioned specific range; and the inventors have newly found that, in stretching after the heat treatment, the changing speed of the alignment of amorphous part and the additive is higher than the changing speed of the alignment of the crystal part. In other words, the alignment of the amorphous part and others can be dominantly changed not greatly moving the crystal part. According to the production method of the invention, the stretching after the crystallization treatment makes the alignment of the amorphous part and the additive perpendicular to the alignment of the crystal part, and the humidity dependence and the wavelength dispersion characteristics of retardation can be freely controlled not changing the direction of the slow axis.

For the TD stretching, the method for stretching in crystallization treatment mentioned above may be employable. The TD stretching may be attained in one stage or in multiple stages. Preferably, both sides of the polymer film are held by a pin tenter, and the film is expanded in the direction perpendicular to the machine direction.

The stretching ration in TD stretching may be suitably defined in accordance with the necessary retardation of the cellulose acylate film, and is preferably from 1 to 50%, more preferably from 1 to 30%, even more preferably from 1 to 5%.

After crystallization and before TD stretching, Re and Rth of the cellulose acylate film are not specifically defined.

Improving the humidity dependence reduces the humidity-dependent fluctuation of display and therefore enhances the display stability.

### (Post-Drying, Handling)

After released from a support or in the drying step after a tenter, the drying temperature of the cellulose acylate film is preferably from 40 to 180 degrees Celsius, more preferably from 70 to 150 degrees Celsius. For further removing the residual solvent, the film is dried at 50 to 150 degrees Celsius, and in this case, preferably, the residual solvent is evaporated away by high-temperature air of which the temperature is changed successively. The method is described in JP-B 5-17844. The drying temperature, the drying air amount and the drying time vary depending on the solvent used, and may be suitably selected in accordance with the type and the combination of the solvents used. The residual solvent amount in the final film is preferably at most 2% by mass, more preferably at most 0.4% by mass, from the viewpoint of producing a film having good dimensional stability.

Regarding the residual solvent amount in a dried film, JP-A 2002-241511 describes an invention of a thin film having a thickness of from 20 to 60 micro meters, in which the residual solvent amount in winding is at most 0.05% by mass for the purpose of preventing the film from deforming with time and for the purpose of making the film optically isotropic with neither scratches nor bubbles or undissolved solids remaining therein. The patent reference discloses preferred embodiments that the difference between the maximum value and the minimum value of the residual solvent amount in the cross direction is at most 0.02% by mass, that the residual solvent amount is preferably at most 0.04% by mass, more preferably at most 0.02% by mass, and that for this, the drying temperature is from 100 to 150 degrees Celsius and the drying time is from 5 to 30 minutes.

Within a range not causing bleeding or vaporization of additives, the film may be processed at a temperature of around 200 degrees Celsius or so as to further enhance the degree of crystallinity.

The process from casting to post-drying may be attained in an air atmosphere or in an inert gas atmosphere such as nitrogen gas. For drying, far-infrared rays, as well as microwaves as in JP-A 8-134336, 8-259706 and 8-325388 may be used.

JP-A 2002-283370 describes a technique of removing dusts and other impurities from web, by arranging a film cleaning apparatus in a site before and/or after a drying apparatus or a thermal correcting apparatus. As the cleaning method, the patent reference discloses a vibration method, a high-pressure wind blowing method, a suction method, as well as a flame treatment (corona treatment, plasma treatment) method, a method of using a sticky roll, etc. As preferred embodiments for preventing further contamination of film with any additional impurities, the patent reference discloses the following: A neutralization apparatus is installed in the winding position in the winding-up original wind tangent line; the neutralization apparatus is so designed that a reversed potential could be given thereto by a discharger or a forced charger in winding so that the charging potential in re-unwinding the original wind could be smaller than ±2 KV; the system is neutralized by the neutralization apparatus by which the forced charge potential can be positively/negatively alternately converted at 1 to 150 Hz; and an ionizer and a neutralization bar to generate an ionic wind is utilized.

### (Surface Treatment)

Preferably, the film is processed for surface treatment for bettering the adhesiveness thereof to other functional layers, such as an optically anisotropic layer formed of a liquid-crystal composition to be mentioned below, a polarizer, etc. Concretely, the surface treatment includes corona discharge treatment, glow discharge treatment, flame treatment, acid treatment, alkali treatment or UV irradiation treatment. Providing an undercoat layer is also preferred.

From the viewpoint of securing the surface smoothness of the film, preferably, the temperature of the film in the treatment is not higher than Tg (glass transition temperature) of the film.

In case where the film is used as a transparent protective film for polarizer and in an embodiment where the main ingredient polymer of the film is cellulose acylate from the viewpoint of the adhesiveness between the film and the polarizing film, especially preferably, the cellulose acylate is acid-processed or alkali-processed, or that is, the cellulose acylate is saponified. An example of alkali saponification is described below.

Preferably, alkali saponification is attained in a cycle that comprises dipping the surface of a film in an alkali solution, then neutralizing it with an acid solution, rinsing it with water and drying it.

Examples of the alkali solution include potassium hydroxide solution, sodium hydroxide solution. The normality concentration of the hydroxide ion in the alkali solution is preferably within a range of from 0.1 to 3.0 N, more preferably from 0.5 to 2.0 N. The temperature of the alkali solution is preferably within a range of from room temperature to 90 degrees Celsius, more preferably from 40 to 70 degrees Celsius.

After surface treatment, the surface energy of the film is preferably at least 55 mN/m, more preferably from 60 mN/m to 75 mN/m.

The surface energy of solid may be determined according to a contact angle method, a wet heat method or an adsorption method as in “Basis and Application of Wetting Technology” (by Realize, issued on Dec. 10, 1989). For the cellulose acylate film of the invention, preferred is a contact angle method.

Concretely, two solutions of which the surface energy is known are separately dropped onto the cellulose acylate film; of the angle between the contact line drawn to the liquid drop and the film surface at the point at which the surface of the liquid drop crosses the film surface, the angle on the side of the liquid drop is defined as a contact angle, and the surface energy of the film can be computed through calculation.

### 2. Retardation Film:

The invention relates to a retardation film comprising the polymer film of the invention and, as formed thereon, an optically anisotropic layer formed of a liquid-crystal composition. The retardation film of the invention is useful for optical compensation in liquid-crystal display devices, especially in TN-mode liquid-crystal display devices.

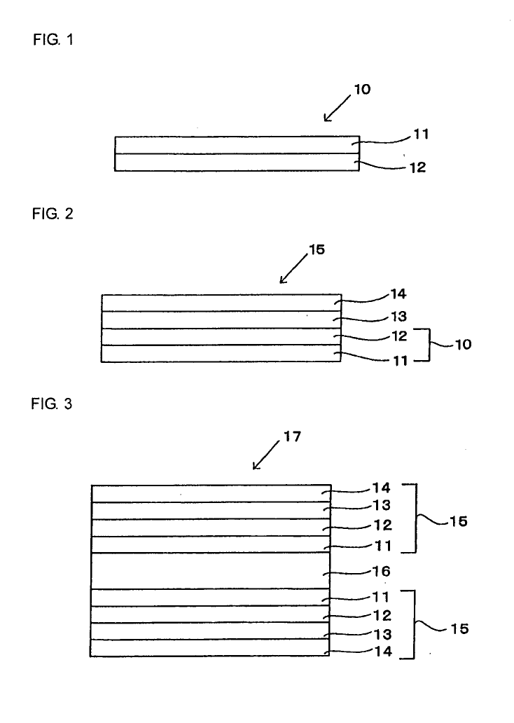

FIG. 1 shows a schematic cross-sectional view of one embodiment of the retardation film of the invention. The retardation film 10 in FIG. 1 comprises an optically anisotropic layer 11 formed of a liquid-crystal composition, and a polymer film 12 of the invention to support the layer 11. Between the optically anisotropic layer 11 and the polymer film 12, an alignment film for controlling the alignment of liquid-crystal molecules may be arranged in forming the optically anisotropic layer 11 formed of a liquid-crystal composition. FIG. 1 is a schematic view, and therefore the relative thickness of the constitutive layers does not always reflect the relative thickness of the layers in an actual optical compensatory film. The same shall apply to FIG. 2 and FIG. 3 to be given below.

### 2′41) Support (Polymer Film of the Invention):

In the retardation film of the invention, the polymer film of the invention is used as the support for the optically anisotropic layer to be described below. In an embodiment where the retardation film is used for optical compensation in TN-mode liquid-crystal display devices, preferred is use of a polymer film which satisfies the above formulae (3) and (4) and of which Re is from 60 to 100 nm and Rth is from 40 to 80 nm.

### 2-(2) Optically Anisotropic Layer:

The retardation film of the invention has at least one optically anisotropic layer formed of a liquid-crystal composition. Optionally, the film may have two or more such layers. In an embodiment where the retardation film is used for optical compensation in TN-mode liquid-crystal display devices, preferably, the optically anisotropic layer has the characteristics that its Re(550) is from 20 to 100 nm, it has no direction in which its Re(550) is 0 nm, and the direction in which the absolute value of its Re(550) is the smallest is neither in the normal direction of the layer nor the in-plane direction. One example of the optically anisotropic layer having such characteristics is an optically anisotropic layer formed by fixing a liquid-crystal composition in a hybrid alignment state. Especially preferred is an optically anisotropic layer formed by fixing a liquid-crystal composition containing a discotic compound in a hybrid alignment state. More preferably, Re(550) of the optically anisotropic layer is from 20 to 40 nm.

The liquid-crystal composition for use in forming the optically anisotropic layer is preferably a liquid-crystal composition capable of forming a nematic phase and a smectic phase. Liquid-crystal compounds are generally divided into rod-shaped liquid-crystal compounds and discotic liquid-crystal compounds based on the shape of their molecules; and in the invention, liquid-crystal compounds of any form are employable.

### Discotic Liquid-Crystal Compound:

As the discotic liquid-crystal compound for use in forming the optically anisotropic layer, preferred are the compounds of the general formula (D1) described in detail in JP-A 2006-76992, paragraph [0012] and later. Concretely, preferred for use in the invention are the compounds described in JP-A 2006-76992, paragraph [0052], and in JP-A 2007-2220, paragraphs [0040] to [0063]. These compounds are preferred as exhibiting high birefringence. Of the compounds of the formula (DI), those exhibiting discotic liquid-crystallinity are preferred, and those exhibiting discotic-nematic phase are more preferred.

Preferred examples of the discotic compounds include those described in JP-A 2005-301206.

### Rod-Shaped Liquid-Crystal Compound:

Rod-shaped liquid-crystal compounds are usable as the material for the optically anisotropic layer.

Use of least two different types of rod-shaped liquid-crystal compounds is preferred for satisfying the necessary properties of the optically anisotropic layer. One preferred combination is a combination of at least one rod-shaped liquid-crystal compound of the following general formula (X) and at least one rod-shaped liquid-crystal compound of the following general formula (XI):

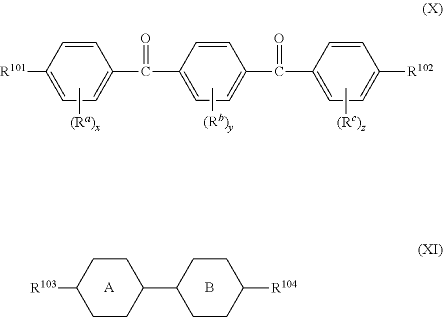

In the formulae, A and B each represent a group of an aromatic or aliphatic hydrocarbon ring or a hetero ring; R¹⁰¹ to R¹⁰⁴ each represent a substituted or unsubstituted, C₁₋₁₂ (preferably C₃₋₇) alkylene chain-containing alkoxy, acyloxy, alkoxycarbonyl or alkoxycarbonyloxy group; R^{a}, R^{b} and R^{c} each represent a substituent; x, y and z each indicate an integer of from 1 to 4.

In the formulae, the alkylene chain contained in R¹⁰¹ to R¹⁰⁴ may be linear or branched. Preferably, the chain is linear. For curing the composition, preferably, R¹⁰¹ to R¹⁰⁴ have a polymerizing group at the terminal thereof. Examples of the polymerizing group include an acryloyl group, a methacryloyl group, an epoxy group, etc.

In the formula (X), preferably, x and z are 0 and y is 1. Preferably, one R^{b} is a meta- or ortho-positioned substituent relative to the oxycarbonyl group or the acyloxy group. Preferably, R^{b} is a C₁₋₁₂ alkyl group (e.g., methyl group), a halogen atom (e.g., fluorine atom), etc.

In the formula (XI), preferably, A and B each are a phenylene group or a cyclohexylene group. Preferably, both of A and B are phenylene groups, or one of them is a cyclohexylene group and the other is a phenylene group.

### Method for Formation of Optically Anisotropic Layer:

Preferably, the optically anisotropic layer is formed by applying a composition containing at least one liquid-crystal compound to the surface of the polymer film of the invention or to the surface of an alignment film formed on the polymer film, then aligning the liquid-crystal compound molecules in a desired alignment state, and curing the composition through polymerization to thereby fix the alignment state. In order that the optically anisotropic layer satisfies the characteristics that it does not have a direction in which its Re(550) is 0 nm and the direction in which the absolute value of its Re(550) is the smallest is neither in the normal direction of the layer nor in the in-plane direction, preferably, the liquid-crystal compound molecules (including both rod-shaped and discotic molecules) are fixed in a hybrid alignment state. Hybrid alignment means that the direction of the director of the liquid-crystal molecules continuously changes in the thickness direction of the layer. For rod-shaped molecules, the director is the long axis direction; and for discotic molecules, the director is the normal line direction to the discotic face.

In order to make the liquid-crystal compounds aligned in a desired alignment state, and for the purpose of bettering the coatability and the curability of the composition, the composition may contain at least one additive.

For hybrid alignment of the molecules of liquid-crystal compound (especially rod-shaped liquid-crystal compound), an additive capable of controlling the alignment on the air interface side of the layer may be added to the composition (hereinafter the additive is referred to as “air-interface alignment controlling agent”). The additive includes low-molecular or high-molecular compounds having a hydrophilic group such as a fluoroalkyl group, a sulfonyl group, etc. Specific examples of the air-interface alignment controlling agent usable here include the compounds described in JP-A 2006-267171.

In case where a coating liquid of the composition is prepared and the optically anisotropic layer is formed in a mode of coating with the liquid, a surfactant may be added to the liquid for bettering the coatability. The surfactant is preferably a fluorine-containing compound, including, for example, the compounds described in JP-A 2001-330725, paragraphs [0028] to [0056]. A commercial product, “Megafac F780” (by Dai-Nippon Ink) is also usable.

And the composition preferably contains at least one polymerization initiator. The polymerization initiator may be selected from thermal or photo-polymerization initiators. In terms of ease of controlling, photo-polymerization initiators are preferable. Examples of the photo-polymerization initiator, which is capable of generating radicals under irradiation with light, include alpha-carbonyl compounds (described in U.S. Pat. Nos. 2,367,661 and 2,367,670), acyloin ether (described in U.S. Pat. No. 2,448,828), alpha-hydrocarbon-substituted aromatic acyloin compounds (described in U.S. Pat. No. 2,722,512), polynuclearquinone compounds (described in U.S. Pat. Nos. 3,046,127 and 2,951,758), combinations of triarylimidazole dimers and p-aminophenyl ketones (described in U.S. Pat. No. 3,549,367), acridine and phenadine compounds (described in JPA No. sho 60-105667 and U.S. Pat. No. 4,239,850), oxadiazole compounds (described in U.S. Pat. No. 4,212,970), acetophenone type compounds, benzoin ether type compounds, benzyl type compounds, benzophenone type compounds, and thioxanthone type compounds. Examples of the acetophenone compound include, for example, 2,2-diethoxyacetophenone, 2-hydroxymethyl-1-phenylpropan-1-one, 4′-isopropyl-2-hydroxy-2-methyl-propiophenone, 2-hydroxy-2-methyl-propiophenone, p-dimethylaminoacetone, p-tert-butyldichloroacetophenone, p-tert-butyltrichloroacetopheone, p-azidobenzalacetophenone. Examples of the benzyl compound include, for example, benzyl, benzyl dimethyl ketal, benzyl β-methoxyethyl acetal, 1-hydroxycyclohexyl phenyl ketone. The benzoin ether compounds include, for example, benzoin, benzoin methyl ether, benzoin ethyl ether, benzoin n-propyl ether, benzoin isopropyl ether, benzoin n-butyl ether, and benzoin isobutyl ether. Examples of the benzophenone compound include benzophenone, methyl o-benzoylbenzoate, Michler's ketone, 4,4′-bisdiethylaminobenzophenone, 4,4′-dichlorobenzophenone. Examples of the thioxanthone compound include thioxanthone, 2-methylthioxanthone, 2-ethylthioxanthone, 2-isopropylthioxanthone, 4-isopropylthioxanthone, 2-chlorothioxanthone, and 2,4-diethylthioxanthone. Of those aromatic ketones serving as a light-sensitive radical polymerization initiator, more preferred are acetophenone compounds and benzyl compounds in point of their curing capability, storage stability and odorlessness. One or more such aromatic ketones may be used herein as a light-sensitive radical polymerization initiator, either singly or as combined depending on the desired performance of the initiator.

For the purpose of increasing the sensitivity thereof, a sensitizer may be added to the polymerization initiator. Examples of the sensitizer are n-butylamine, triethylamine, tri-n-butyl phosphine, and thioxanthone.

Plural types of the photopolymerization initiators may be combined and used herein, and the amount thereof is preferably from 0.01 to 20% by mass around of the solid content of the coating liquid, more preferably from 0.5 to 5% by mass around. For light irradiation for polymerization of the liquid-crystal compound, preferably used are UV rays.

The composition may comprise a polymerizable non-liquid crystal monomer(s) along with the polymerizable liquid crystal compound. Examples of the polymerizable monomer include compounds having a vinyl, vinyloxy, acryloyl or methacryloyl. For improving the durability, polyfunctional monomers, having two or more polymerizable groups, such as ethyleneoxide-modified trimethylolpropane acrylates maybe used.

The amount of the polymerizable non-liquid crystal monomer is preferably equal to or less than 15% by mass around and more preferably from 0 to 10% by mass around with respect to the amount of the liquid crystal compound.

The optically anisotropic layer may be prepared as follows. The composition is prepared as a coating liquid, and applied to a surface of an alignment layer disposed on the polymer film of the invention. After that, the composition is dried to remove solvent therefrom, thereby align liquid crystal molecules. Then, the alignment is fixed via polymerization, and an optically anisotropic layer is prepared. Examples of the alignment layer which can be used in the invention include polyvinyl alcohol films and polyimide films.

The coating method may be any known method of curtain-coating, dipping, spin-coating, printing, spraying, slot-coating, roll-coating, slide-coating, blade-coating, gravure-coating or wire bar-coating.

Drying the coating layer may be carried out under heat. During drying it, while solvent is removed from it, liquid crystal molecules therein are aligned in a preferred state.

Next, the layer is irradiated with UV light to carry out polymerization reaction, and then the alignment state is immobilized to form an optically anisotropic layer. The irradiation energy is preferably from 20 mJ/cm² to 50 J/cm², more preferably from 100 mJ/cm² to 800 mJ/cm². For promoting the optical polymerization, the light irradiation may be attained under heat.

The thickness of the optically anisotropic layer may be from 0.1 to 10 micro meters or from 0.5 to 5 micro meters.

### 3. Polarizing Plate:

The invention also relates to a polarizing plate comprising at least the polymer film of the invention or the retardation film of the invention, and a polarizing film. In incorporating the polarizing plate of the invention into a liquid-crystal display device, preferably, the polymer film or the retardation film of the invention is arranged on the liquid-crystal cell side. In an embodiment having the retardation film of the invention, preferably, the back (on which the optically anisotropic layer is not formed) of the polymer film of the invention serving as a support is stuck to the surface of the polarizing film. In any embodiment, preferably, the polymer film of the invention and the polarizing films are stuck in such a manner that the crossing angle between the in-plane slow axis of the polymer film and the transmission axis of the polarizing film is nearly 0 degree. The crossing angle needs not be strictly 0 degree, and an acceptable error of around ±5 degrees in production does not have any influence on the effect of the invention, but is acceptable here. Preferably, a protective film such as a cellulose acylate film or the like is stuck to the other surface of the polarizing film.

FIG. 2 shows a schematic cross-sectional view of one embodiment of the polarizing plate of the invention. The polarizing plate 15 shown in FIG. 2 comprises a polarizing film 13 and has, on the surfaces thereof, a retardation film 10 of the invention and a protective film 14 for protecting the polarizing film 13. The support 12 to constitute the retardation film 10 is the polymer film of the invention, and the back thereof, or that is, the side thereof on which the optically anisotropic layer 11 is not formed is stuck to the surface of the polarizing film 13. When the polarizing plate 15 is incorporated into a liquid-crystal display device, the retardation film 10 is arranged to face the liquid-crystal cell side. Though not shown, the polarizing plate 15 in FIG. 2 may have any other functional layer. For example, a diffusion layer, an antiglare layer and the like may be formed on the protective film 14.

The other members than the polymer film or the retardation film of the invention to constitute the polarizing plate of the invention are described below along with various materials usable for their production.

### Polarizing Film

Examples of a polarizing film (polarizer) include an iodine-base polarizing film, a dye-base polarizing film with a dichroic dye, and a polyene-base polarizing film, and any of these is usable in the invention. The iodine-base polarizing film and the dye-base polarizing film are produced generally by the use of polyvinyl alcohol films.

### Protective Film

As the protective film to be bonded to the other surface of the polarizing film, preferably used is a transparent polymer film. “Transparent” means that the film has a light transmittance of at least 80%. As the protective film, preferred are cellulose acylate films, and polyolefin films containing polyolefin(s). Of cellulose acylate films, preferred are cellulose triacetate film. Of polyolefin films, preferred are cyclic polyolefin-containing polynorbornene films.

The thickness of the protective film is preferably from 20 to 500 micro meters, or from 50 to 100 micro meters.

### Light-Scattering Film

The polarizing plate of the invention may contain a light-scattering film disposed on one surface of the polarizing film. The light-scattering film may be a single layer film, or multilayered film. One example of the multilayered film is a light-scattering film containing a light transmissive film and a light-scattering layer disposed on thereon. The light-scattering film may contribute to improving the viewing angle characteristics when the viewing angle is inclines in the vertical and horizontal directions. In an embodiment where the antireflection layer is disposed outside the polarizing film disposed on the displaying side, the light-scattering film may exhibit an especially high effect. The light-scattering film (or the light scattering layer contained in the film) may be formed of a composition containing fine particles dispersed in a binder. The fine particles may be inorganic particles or organic particles. Preferably, the difference in the refractive index between the binder and the fine particles is from 0.02 to 0.20 or so. The light-scattering film (or the light scattering layer contained in the film) may additionally have a hard coat function. Regarding the light-scattering film usable in the invention, referred to are JPA No. hei 11-38208 where a front scattering coefficient is specifically defined; JPA No. 2000-199809 where the relative refractive index of transparent resin and fine particles is specifically defined to fall within a specific range; and JPA No. 2002-107512 where the haze value is defined to be at least 40%.

### Production Method for Polarizing Plate:

The polarizing plate of the invention may be produced as a long polarizing plate. For example, using the polymer film of the invention formed as a long film, an alignment film-forming coating liquid is optionally applied on its surface to form an alignment film thereon, and subsequently, an optically anisotropic layer-forming coating liquid is continuously applied thereto and dried to make the formed film have a desired alignment state, and thereafter this is irradiated with light to fix the alignment state to form an optically anisotropic layer, thereby producing a long retardation film of the invention. Subsequently, the retardation film may be once wound up into a roll. Separately, a long polarizing film and a long polymer film for protective film are individually wound up into a roll; and these are stuck in a mode of roll-to-roll operation to thereby produce a long polarizing plate. The long polarizing plate is, for example, transported and stored as a roll thereof; and when incorporated into a liquid-crystal display device, it is cut into a predetermined size. The polarizing plate of the invention needs not be a long product, and the production method described here is merely one example.

In producing the polymer film of the invention, when it is stretched in the machine direction, then it may be roll-to-roll worked to produce a polarizing plate; and the embodiment is favorable as simplifying the production process and as further enhancing the axial accuracy in sticking the film to a polarizing film.

### 4. Liquid-Crystal Display Device:

The polymer film, the retardation film and the polarizing plate of the invention are usable in various modes of liquid-crystal display devices. These are usable in any of transmission-type, reflection-type or semitransmission-type liquid-crystal display devices. The polymer film of the invention satisfies the above formulae (3) and (4) and is a colorless polymer film, and therefore does not bring about any unfavorable coloration caused by the polymer film, and contributes toward improving the viewing angle characteristics of liquid-crystal display devices.

In particular, the retardation film of the invention is effective in a liquid-crystal display device comprising a pair of substrates which are placed oppositely to each other and at least one of which has an electrode, and containing a nematic liquid-crystal material sandwiched between the pair of substrates, in which the liquid-crystal molecules of the nematic liquid-crystal material are aligned nearly vertically to the surface of the pair of substrates at the time of black level of display, especially a twist nematic (TN) mode liquid-crystal display device. In particular, the invention is effective in an embodiment of a transmission-type twist-nematic mode liquid-crystal display device.

In such a TN-mode liquid-crystal display device, preferably, two retardation films of the invention are arranged symmetrically to the liquid-crystal cell positioned at the center, and also preferably, the polarizing plates of the invention are arranged as upper and lower polarizing plates (on the viewers' side and on the backlight side) symmetrically to the liquid-crystal cell positioned at the center. The product of the thickness, d (micron), and the refractivity anisotropy, Δn, of the liquid-crystal layer of the TN-mode liquid-crystal cell, Δn·d, is generally from 0.1 to 1.5 micro meters or so.

FIG. 3 shows a schematic cross-sectional view of a TN-mode liquid-crystal display device that is one embodiment of the liquid-crystal display device of the invention. The liquid-crystal display device shown in FIG. 3 comprises a TN-mode liquid-crystal cell 16, and two polarizing plates 15 of the invention as arranged symmetrically to sandwich the cell 16 therebetween. The liquid-crystal cell 16 has a liquid-crystal layer formed of a nematic liquid-crystal material; and the liquid-crystal layer is so designed that it is in a twisted alignment state under no driving voltage application thereto, and is in a vertical alignment state to the substrate surface under driving voltage application thereto. The upper and lower polarizing plates 15 are so arranged that the transmission axes of their polarizing films 13 are vertical to each other; and therefore, in no driving voltage application, the linearly polarized light coming in the liquid-crystal cell 16 from the backlight (not shown) arranged at the back of the lower polarizing plate 15 rotates by 90° along the twisted alignment of the liquid-crystal layer, and then passes through the transmission axis of the upper polarizing plate 15 to give the white state. On the other hand, in driving voltage application, the linearly polarized light coming in the liquid-crystal cell 16 directly passes through the cell 16 while keeping its polarization state, and therefore, this is blocked by the upper polarizing plate 15 to give the black state. The retardation films 10 arranged on and below the liquid-crystal cell 16 compensates for birefringence occurring in oblique directions at the time of black level of display.

### Liquid-Crystal Display Device of Preferred Embodiment of the Invention:

Preferably, the liquid-crystal display device of the invention is a TN-mode liquid-crystal display device comprising a liquid-crystal cell and a polarizing plate arranged on at least one side of the liquid-crystal cell, in which the liquid-crystal cell includes red, green and blue color filters and liquid-crystal layers corresponding to the red, green and blue color filters, respectively, and the liquid-crystal layers have a multi-gap structure satisfying a relationship of dR≧dG>dB, or dR>dG≧dB, and the polarizing plate comprises a polarizing film and the optically compensatory film of the invention arranged on the liquid-crystal cell side of the polarizing film. Having the constitution, the liquid-crystal display device enjoys the advantageous effect of the invention mentioned above, and can prevent white color shift to occur in sideways directions. The embodiment of the liquid-crystal display device of the invention that comprises a liquid-crystal cell having such a multi-gap structure will be hereinunder referred to as “liquid-crystal display device of a preferred embodiment of the invention”.

The liquid-crystal display device of the preferred embodiment of the invention preferably has polarizing plates arranged on both sides of the liquid-crystal cell therein, in which, more preferably, the polarizing plates arranged on both sides of the liquid-crystal cell each comprises the optically compensatory film of the invention and a protective layer.

In the liquid-crystal display device of the preferred embodiment of the invention, the liquid-crystal layer has a multi-gap structure, and therefore, depending on the thickness of the liquid-crystal layer corresponding to the individual color filters, retardation differs. As a whole of the liquid-crystal layer, the liquid-crystal layer could have a larger retardation at a longer wavelength, or that is, could have so-called reversed wavelength dispersion characteristics of retardation.

When the liquid-crystal layer having reversed wavelength dispersion characteristics of retardation is combined with the retardation film of the invention, then the light intensity to run on the viewing side of the liquid-crystal display device is constant irrespective of the wavelength; and therefore, the device enjoys the advantageous effect of the invention mentioned above, and can prevent white color shift to occur in sideways directions. The details of the constituent members of the liquid-crystal display device of the preferred embodiment of the invention are described below; however, the invention is not limited to the following specific embodiments.

The liquid-crystal cell includes red, green and blue color filters, and liquid-crystal layers corresponding to the red, green and blue color filters, respectively. Preferably, the liquid-crystal layer is sandwiched between the first substrate and the second substrate. Preferably, the color filter is formed on the first substrate. On the second substrate, preferably formed are a TFT element for controlling the electro-optical properties of liquid crystals, and a scanning line for giving a gate signal to the active element and a signal line for giving a source signal thereto.

In the liquid-crystal display device of the preferred embodiment of the invention, the color filter may be formed on any side of the first substrate or the second substrate.

The color filter for use in the liquid-crystal display device of the preferred embodiment of the invention may be any one having three primary color filters of red, green and blue filters. The color filter may further have any other color filter of a deep red filter. Preferably, the red filter has a maximum value of transmittance within a wavelength range of from 400 nm to 480 nm, the green filter has a maximum value of transmittance within a wavelength range of from 520 nm to 580 nm, and the blue filter has a maximum value of transmittance within a wavelength range of from 590 nm to 780 nm. The maximum value of transmittance of each color is preferably at least 80%.

The thickness of the color filter is suitably selected. Preferably, the thickness is from 0.4 to 4.0 micro meters, more preferably from 0.7 to 3.5 micro meters. As the pixel pattern of the color filter, employable is any pattern of stripes, mosaics, triangles, blocks, etc.

In the pixel part of the color filer, if desired, a black matrix may be arranged in the boundary between different color filters, or a protective layer may be arranged to cover the color filter, or a transparent conductive film may be arranged on the protective layer.

The color material to form the color filter is not specifically defined. For example, employable are dyes and pigments. Dye-based color filters are excellent in transparency and contrast and are characterized by having a lot of spectral variations. On the other hand, pigment-based color filters are excellent in heat resistance and lightfastness. For forming the color filters, for example, employable are a photolithography method, an etching method, a printing method, an electrodeposition method, an inkjet method, a vapor evaporation method, etc.

Preferably, the color material to form the color filter is pigment. The pigment-based color filter may be formed of a color resin prepared by dispersing pigment in a binder resin such as acrylic or polyimide resin. The pigment includes, for example, Color index Generic Name: Pigment Red 177 (crimson lake), Pigment Red 168, Pigment Green 7 (phthalocyanine green), Pigment Green 36, Pigment Blue 15 (phthalocyanine blue), Pigment Blue 6, Pigment Yellow 83 (azo yellow), etc. For color control, different color pigments may be mixed and combined for use herein.

Regarding the dispersion condition of the pigment, the mean particle size of the secondary particles of the pigment is preferably at most 0.2 micro meters, more preferably at most 0.1 micro meters. The secondary particles are aggregates of some fine pigment particles (primary particles. The pigment-based color filter having such a dispersion condition may have a high transmittance and have little negative influence on polarizability.

The liquid-crystal layers to be in the liquid-crystal display device of the preferred embodiment of the invention have a multi-gap structure satisfying a relationship of dR≧dG>dB, or dR>dG≧dB in point of the thickness of the layer corresponding to each color filter. dR, dG and dB each mean the thickness of the liquid-crystal layer corresponding to the red, green and blue color filters, respectively. Most preferably, the thickness of the liquid-crystal layers corresponding to the respective color filters satisfies dR>dG>dB. However, in case where dR=dG and dG>dB, the light leakage from the liquid-crystal display device in a blue region that may have some significant influence could be reduced, and therefore the device of the type could have relatively good display characteristics. In case where dG=dB and dR>dG, similarly the device is relatively good.

(dR−dG) and (dG−dB) each are preferably from 0.1 to 1.5 micro meters, more preferably from 0.5 to 1.2 micro meters. Preferably, dR is from 2.8 to 7.9 micro meters, dG is from 2.7 to 5.7 micro meters, and dB is from 2.6 to 5.6 micro meters.

Preferably in the liquid-crystal display device of the invention, dR and dB satisfy 0 micro meters<dR−dB≦3.0 Mm, as further reducing the white color shift in sideways directions.

More preferably, the multi-gap structure of the liquid-crystal layers satisfies 0.2 micro meters≦dR−dB≦3.0 micro meters, even more preferably 1.0 micro meters≦dR−dB≦2.5 micro meters.

Any suitable method is employable for forming the multi-gap structure. Preferably, the multi-gap structure is formed by changing the thickness of the red, green and blue color filters individually. Regarding the thickness of the color filters, preferably, blue of the three primary colors is the thickest, next green is thicker, and red is thinnest. The thickness of the color filters may be changed by increasing or decreasing the amount of the color resin to be coated in case where a photolithography method or an etching method is selected. In case where an electrodeposition method or a vapor evaporation method is selected, the dipping time in the electrodeposition liquid or the vapor evaporation time may be varied to thereby control the thickness of the color filters.

In another method, the multi-gap structure may be formed by providing an undercoat layer on the first substrate side of the individual color filters, and changing the thickness of the undercoat layer corresponding to the color of the color filter. In still another method, the multi-gap structure may be formed by providing an overcoat layer on the liquid-crystal layer side of the individual color filters, and changing the thickness of the overcoat layer corresponding to the color of the color filter. In this, the overcoat layer may serve also as the protective layer for the color filter.

The thickness of the individual color filters may be the same or may differ for different color. In this case, the multi-gap structure may be formed by suitably controlling the thickness of the undercoat layer or the overcoat layer. The liquid-crystal cell for use in the liquid-crystal display device of the preferred embodiment of the invention may have both the undercoat layer and the overcoat layer, or may have the undercoat layer and/or the overcoat layer only in some color filters of the red, green and blue color filters.

The material to form the undercoat layer and the overcoat layer is preferably one excellent in transparency and heat resistance. The material includes, for example, polyimide resins, and UV-curable resins such as acrylic resins and epoxy resins.

Regarding the wavelength dispersion characteristics of retardation of the liquid-crystal layer, preferably, the layer has reversed wavelength dispersion characteristics of retardation; and the liquid-crystal layer of the type is effective for reducing the light leakage in a blue region that has heretofore been a cause of display characteristics degradation.

### 5. Measurement Method

The methods for measuring some properties such as optical properties are described in detail below.

### (1) Re and Rth

In this description, Re(λ) and Rth(λ) are retardation (nm) in plane and retardation (nm) along the thickness direction, respectively, at a wavelength of λ. Re (λ) is measured by applying light having a wavelength of λnm to a film in the normal direction of the film, using KOBRA 21ADH or WR (by Oji Scientific Instruments).

When a film to be analyzed is expressed by a monoaxial or biaxial index ellipsoid, Rth(λ) of the film is calculated as follows.

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (1) and (2):

$$\begin{matrix}Re ( θ ) = [ n x - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & ( 1 ) \\ Rth = ( \frac{nx + ny}{2} - nz ) \times d & ( 2 )\end{matrix}$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λnm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

In the description, the measurement wavelength for Re or Rth is Λ=550 nm in the visible light region, unless otherwise specifically noted. And in the description, the numerical data, the numerical range and the qualitative expression (for example, “equivalent”, “same”, etc.) indicating the optical characteristics should be so interpreted as to indicate the numerical data, the numerical range and the qualitative expression that include the error range generally acceptable for liquid-crystal display devices and their component parts.

### (2) Substitution Degree

By measuring the binding level of acetic acid and/or a fatty acid with 3 to 22 carbon atoms in substitution with the hydroxyl groups in cellulose, the substitution degree can be calculated. The methods for the measurement are according to ASTM D-817-91.

### Examples

The present invention will be explained to further detail, referring to Examples. Note that the materials, reagents, amounts and ratios of substances, operations and so forth explained in Examples below may appropriately be modified without departing from the spirit of the present invention. The scope of the present invention is, therefore, not limited to the specific examples described below.

### 1. Production of Polymer Film:

A cellulose acylate solution A-1 having the following formulation was prepared.

Composition of Cellulose Acylate Solution A

| | |
|---|---|
| Cellulose Acetate having a mean degree of | 100.0 mas. pts. |
| substitution of 2.94 | |
| Methylene Chloride (first solvent) | 475.9 mas. pts. |
| Methanol (second solvent) | 113.0 mas. pts. |
| Butanol (third solvent) | 5.9 mas. pts. |
| Silica Particles having a mean particle size of 16 nm | 0.13 mas. pts. |
| (AEROSIL R972, by Nippon Aerosil) | |
| High-molecular-weight Plasticizer* | 10.0 mas. pts. |
| Wavelength Dispersion Characteristics- | as in the Table |
| Controlling Agent (shown in the following Table) | |
| Citrate | 0.01 mas. pts. |

*Condensate of ethanediol/adipic acid (1/1 by mol) (having a number-average molecular weight of 1000)
Compound AA (optical anisotropy-controlling agent)

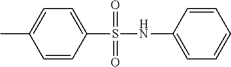

The cellulose acylate solution A prepared in the above was heated at 30 degrees Celsius, and cast on a mirror-surface stainless support of a drum having a diameter of 3 m, through a casting machine. The surface temperature of the support was set at −5 degrees Celsius, and the coating width was 200 cm. The spatial temperature in the entire casting zone was set at 15 degrees Celsius. At the point of 50 cm before the endpoint of the casting zone, the cellulose acylate film that had been cast and rotated was peeled away from the drum in which the residual solvent amount was about 260%, then conveyed with a pin tenter, and stretched in the machine direction at the stretching ratio shown in Table 1. The film was so dried that the film surface temperature could be 80 degrees Celsius when the residual solvent amount was 40%. Further, this was dried at 140 degrees Celsius for 20 minutes to give a cellulose acylate film having a thickness of 80 micro meters.

The stretching ratio (%) of the film was determined as follows: Marked lines were given at regular intervals to the film in the direction perpendicular to the machine direction, and the distance between the lines was measured before and after the stretching step. The stretching ratio was computed according to the following formula. In Examples and Comparative Examples, the stretching ratio of the film was determined in the same manner.

Stretching Ratio(%)=100×[(distance between the marked lines after stretching)−(distance between the marked lines before stretching)]/(distance between the marked lines before stretching)

The optical properties of the cellulose acetate film obtained in the above are shown in Table 1 below. The amount of the wavelength dispersion characteristics-controlling agent added in film production, λmax, λ_{1/2}−λmax, and the matter as to whether or not the compound added satisfies the formulae (1) and (2) are shown in Table 1 (in Table 1 “O” means that the compound satisfies the formula, and “x” means that the compound does not satisfy the formula).

### 2. Production of Retardation Film:

### (1) Saponification of Cellulose Acetate Film:

The cellulose acetate film obtained in the above was led to pass through a dielectric heating roll unit at a temperature of 60 degrees Celsius to elevate the film surface temperature to 40 degrees Celsius. Using a bar coater, an alkali solution having the following composition was applied to it in an amount of 14 mL/m², and kept staying under a steam-type far-IR heater (by Noritake Company) heated at 110 degrees Celsius for 10 seconds. Also using a bar coater, pure water was applied to it in an amount of 3 mL/m². In this stage, the film temperature was 40 degrees Celsius. Next, this was rinsed with water using a fountain coater and dewatered with an air knife, and this operation was repeated three times. Subsequently, this was kept staying in a drying zone at 70 degrees Celsius for 2 seconds and dried therein.

Composition of Alkali Solution for Saponification

| | | |
|---|---|---|
| Potassium Hydroxide | 4.7 | mas · pts. |
| Water | 15.7 | mas · pts. |
| Isopropanol | 64.8 | mas · pts. |
| Propylene glycol | 14.9 | mas · pts. |
| Surfactant (C₁₆H₃₃O(CH₂CH₂O)₁₀H) | 1.0 | mas · pt. |

### (2) Formation of Alignment Film:

Using a #14 wire bar coater, an alignment film-forming coating liquid having the composition mentioned below was applied onto the saponified surface of the saponified cellulose acetate film, in an amount of 24 mL/m², and dried with hot air at 100 degrees Celsius for 120 seconds. The thickness of the alignment film was 1.0 micro meters. Next, the formed film was rubbed in the direction of 0° relative to the lengthwise direction (machine direction) of the film of 0°.

Composition of Alignment Film-Forming Coating Liquid

| | |
|---|---|
| Modified polyvinyl alcohol mentioned below | 40 mas. pts. |
| Water | 728 mas. pts. |
| Methanol | 228 mas. pts. |
| Glutaraldehyde (crosslinking agent) | 2 mas. pts. |
| Citrate (AS3, by Sankyo Chemical) | 0.69 mas. pts. |

Modified Polyvinyl Alcohol:

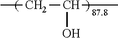

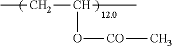

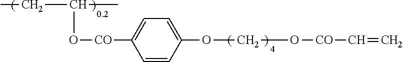

### (3) Formation of Optically Anisotropic Layer:

Using a wire bar, an optically anisotropic layer-forming coating liquid having the composition mentioned below was applied onto the rubbed surface of the alignment film. Next, this was heated in a thermostat bath at 130 degrees Celsius for 120 seconds whereby the discotic liquid-crystal compound was aligned. Next, using a high-pressure mercury lamp of 160 W/cm at 80 degrees Celsius, this was irradiated with UV rays for 40 seconds for crosslinking to thereby polymerize the discotic liquid-crystal compound. Subsequently, this was left cooled to room temperature. Re, as measured at a wavelength of 550 nm, of the formed optically anisotropic layer and the thickness thereof are as in the following Table. In the optically anisotropic layer, the molecules of the discotic liquid-crystal compound were fixed in a hybrid alignment state; the layer did not have a direction in which its Re(550) could be 0 nm, and the direction in which the absolute value of Re(550) of the layer could be the smallest was neither in the normal line direction of the layer nor in the in-plane direction. This was confirmed as follows: Light having a wavelength of 550 nm was applied to the film in the directions stepwise inclined to 50 degrees from the normal line direction of the film at intervals of 10 degrees on one side, and retardation of the film was measured at the inclined 11 points in all. The found data of retardation of the film were processed with KOBRA 21AH or WR, based on the estimated value of the mean refractive index and the inputted thickness thereof, and the optical characteristics as above of the film were confirmed.

Composition of Optically Anisotropic Layer-Forming Coating Liquid

| | |
|---|---|
| Methyl Ethyl Ketone | 270 mas. pts. |
| Discotic Liquid-Crystal Compound shown below | 90 mas. pts. |
| (Compound (1)) | |
| Discotic Liquid-Crystal Compound shown below | 10 mas. pts. |
| (Compound (2)) | |
| Air-Interface Alignment-Controlling Agent having the | 1.0 mas. pt. |
| following structure | |
| Photopolymerization Initiator (Irgacure 907, by Ciba Japan) | 3.0 mas. pts. |
| Sensitizer (Kayacure DETX, by Nippon Kayaku) | 1.0 mas. pt. |

Compound (1) 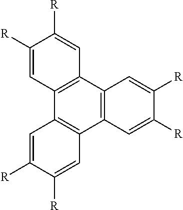 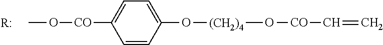
Compound (2) 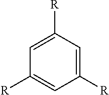 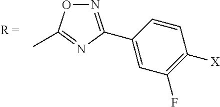
X = —O(CH₂)₂CH(CH₃)OCOCH═CH₂
Air-Interface Alignment-Controlling Agent

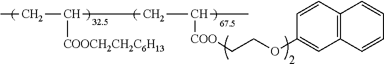

The thickness of the optically anisotropic layer was so controlled that retardation in plane Re could be 28 nm. The thickness of the optically anisotropic layer was from 0.9 micro meters to 1.2 micro meters or so.

### 3. Production of Polarizing Plate:

A polyvinyl alcohol (PVA) film having a thickness of 80 micro meters was dyed by dipping it in an aqueous iodine solution having an iodine concentration of 0.05% by mass at 30 degrees Celsius for 60 seconds, and then while dipped in an aqueous boric acid solution having a boric acid concentration of 4% by mass, this Was stretched in the machine direction by 5 times the original length, and thereafter dried at 50 degrees Celsius for 4 minutes to give a polarizing film having a thickness of 20 micro meters.

The exposed face of the optical film of cellulose acylate film produced in the above (the face thereof not coated with the optically anisotropic layer) was dipped in an aqueous sodium hydroxide solution (1.5 mol/L) at 55 degrees Celsius, and then fully washed with water to remove sodium hydroxide. Next, this was dipped in an aqueous diluted sulfuric acid solution (0.005 mol/L) at 35 degrees Celsius for 1 minute, then dipped in water to fully remove the aqueous diluted sulfuric acid solution. Finally, the sample was fully dried at 120 degrees Celsius.

The optical film saponified in the manner as above was combined with a commercial cellulose acetate film that had been saponified also in the same manner as above, the above-mentioned polarizing film was sandwiched between them, and these were stuck together with a polyvinyl alcohol adhesive in such a manner that the saponified surfaces of the films could face each other, thereby fabricating a polarizing plate having the layer constitution as in FIG. 2. The commercial cellulose acetate film was Fujitac TF80UL (by FUJIFILM). In this, the polarizing film and the protective film on both surfaces of the polarizing film were produced all as rolls, and therefore, the machine direction of every roll was parallel to each other, and the rolls were unrolled and continuously stuck together. Accordingly, the absorption axis of the polarizing film was parallel to the machine direction of the optical film roll (the casting direction in film formation).

### 4. Production and Evaluation of TN-Mode Liquid-Crystal Display Device:

A TN-mode liquid-crystal display device having the same constitution as in FIG. 3 was constructed. Concretely, in a liquid-crystal display device having a TN-mode liquid-crystal cell (Nippon Acer's AL2216W), a pair of polarizing plates were removed, and in place of them, the polarizing plate fabricated in the above was stuck each one on both the viewers' side and the backlight side, using an adhesive, in such a manner that its optically anisotropic layer could face the side of the liquid-crystal cell. In this, the two polarizing plates were so disposed that the transmission axis of the polarizing plate on the viewers' side was perpendicular to the transmission axis of the polarizing plate on the backlight side. In that manner, the TN-mode liquid-crystal display device was constructed.

The produced liquid-crystal display device was evaluated as follows: Evaluation of viewing angle characteristics in both vertical and horizontal directions:

The produced liquid-crystal display device was tested, using a tester “EZ-Contrast 160D” (by ELDIM), for the viewing angle thereof from the time of black level (L1) to the time of white level (L8) of display. In both the horizontal and the vertical directions at a polar angle of 80 degrees, the mean value of the contrast ratio (white transmittance/black transmittance) was determined. The device was evaluated according to the following criteria:

5: at least 50.

4: From 45 to less than 50.

3: From 35 to less than 45.

2: From 30 to less than 35.

1: Less than 30.

### Yellowing Evaluation:

The produced liquid-crystal display device was checked visually for the degree of discoloration (yellowing) according to the following criteria.

⊚: No yellowing.
◯: Slight yellowing, but no problem for practical use.
x: Yellowing to a problematic degree for practical use.

### Lighffastness Evaluation:

The polarizing plates in Examples 1 to 7 each were set in “Super Xenon Weather Meter SX75” (by Suga Test Instruments), and irradiated with light under the condition of 150 W/m² for 200 hours, on the side of the protective film (Fujitac TF80UL) of the polarizing plate. Subsequently, this was used in producing a TN-mode liquid-crystal display device in the same manner as above, and the viewing angle characteristics of the device were evaluated according to the same criteria as above.

The evaluation results are shown in the following Tables.

| | Wavelength | | | | | | Stretching | | Crystallization | | | | | | | | |
|---|---|---|---|---|---|---|---|---|---|---|---|---|---|---|---|---|---|
| | Dispersion | | | | | | Step | | Step | | | | | | | | |
| | Characteristics-Controlling | | | | | | Stret- | Residual | | Residual | Film Properties | | | | | | |
| | Agent | | | | | | ching | Solvent | | Solvent | Re | Rth | ΔRe | ΔRth | Displaying | | Lightfastness |
| Ex- | Com- | λmax | | λ1/2-λmax | | Amount | Ratio | Amount | T | Amount | (nm) | (nm) | (nm) | (nm) | Evaluation | | Evaluation |
| am- | pound | (nm) | | (nm) | | (% by | (%) | (%) | (° C.) | (%) | (5) | (6) | (3) | (4) | Viewing | Yello- | Viewing |
| ple | No. | 360-400 | (1) | ≦20 | (2) | mass) | 3-100 | 100-300 | 50-100 | 10-100 | 60-100 | 40-80 | ≦0 | ≧0 | angle | wing | angle |
| 1 | I-1 | 376 | ◯ | 16 | ◯ | 1.0 | 35 | 270 | 80 | 30 | 90 | 55 | −9 | 15 | 5 | ⊙ | 5 |
| 2 | I-2 | 381 | ◯ | 13 | ◯ | 0.5 | 35 | 270 | 80 | 30 | 85 | 55 | −11 | 20 | 5 | ⊙ | 2 |
| 3 | I-3 | 393 | ◯ | 11 | ◯ | 0.5 | 25 | 270 | 80 | 30 | 85 | 60 | −10 | 25 | 5 | ◯ | 5 |
| 4 | I-4 | 377 | ◯ | 16 | ◯ | 1.5 | 35 | 270 | 80 | 30 | 85 | 60 | −10 | 15 | 5 | ⊙ | 5 |
| 5 | I-5 | 390 | ◯ | 12 | ◯ | 0.4 | 25 | 270 | 80 | 30 | 90 | 75 | −13 | 25 | 5 | ◯ | 3 |
| 6 | I-6 | 400 | ◯ | 13 | ◯ | 0.3 | 25 | 270 | 80 | 30 | 90 | 65 | −15 | 30 | 5 | ◯ | 5 |
| 7 | I-7 | 387 | ◯ | 13 | ◯ | 1.0 | 30 | 270 | 80 | 30 | 80 | 45 | −12 | 20 | 5 | ◯ | 2 |
| 8 | I-8 | 380 | ◯ | 14 | ◯ | 2.0 | 30 | 270 | 80 | 30 | 95 | 65 | −13 | 20 | 5 | ◯ | 2 |
| 9 | II-1 | 387 | ◯ | 7 | ◯ | 1.0 | 35 | 270 | 80 | 30 | 85 | 65 | −7 | 13 | 4 | ⊙ | 2 |
| 10 | II-2 | 400 | ◯ | 7 | ◯ | 0.8 | 20 | 270 | 80 | 30 | 90 | 70 | −8 | 15 | 5 | ◯ | 2 |
| 11 | I-9 | 369 | ◯ | 15 | ◯ | 1.5 | 40 | 270 | 80 | 30 | 90 | 60 | −2 | 2 | 3 | ⊙ | 1 |
| 12 | II-3 | 386 | ◯ | 7 | ◯ | 1.0 | 45 | 270 | 80 | 30 | 80 | 60 | −1 | 1 | 3 | ⊙ | 1 |

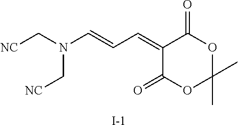

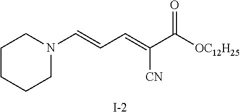

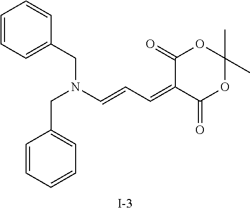

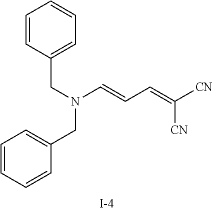

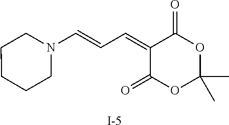

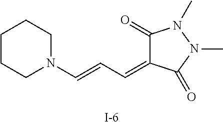

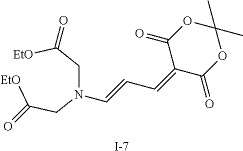

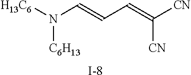

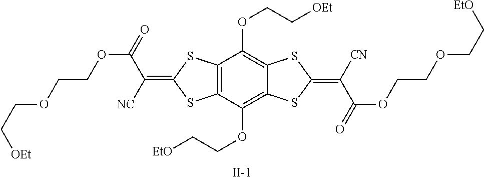

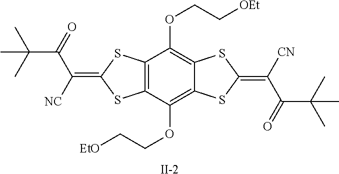

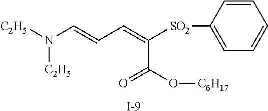

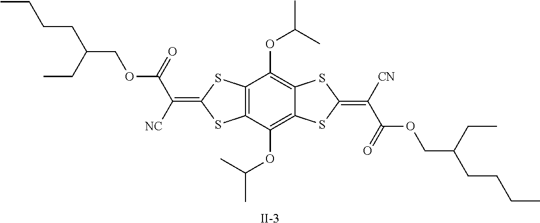

| | Wavelength | | | | | | Stretching | | Crystallization | | | | | | | |
|---|---|---|---|---|---|---|---|---|---|---|---|---|---|---|---|---|
| Com- | Dispersion | | | | | | Step | | Step | | | | | | | |
| para- | Characteristics-Controlling | | | | | | Stret- | Residual | | Residual | Film Properties | | | | | |
| tive | Agent | | | | | | ching | Solvent | | Solvent | Re | Rth | ΔRe | ΔRth | Displaying | |
| Ex- | Com- | λmax | | λ1/2-λmax | | Amount | Ratio | Amount | T | Amount | (nm) | (nm) | (nm) | (nm) | Evaluation | |
| am- | pound | (nm) | | (nm) | | (% by | (%) | (%) | (° C.) | (%) | (5) | (6) | (3) | (4) | Viewing | Yello- |
| ple | No. | 360-400 | (1) | ≦20 | (2) | mass) | 3-100 | 100-300 | 50-100 | 10-100 | 60-100 | 40-80 | ≦0 | ≧0 | angle | wing |
| 1 | C-1 | 352 | X | 28 | X | 5.0 | 50 | 270 | 80 | 30 | 10 | 20 | 7 | −8 | 1 | X |
| 2 | C-2 | 349 | X | 23 | X | 2.0 | 50 | 270 | 80 | 30 | 15 | 30 | −2 | 2 | 2 | ⊙ |
| 3 | C-3 | 405 | X | 11 | ◯ | 1.5 | 20 | 270 | 80 | 30 | 90 | 65 | −16 | 27 | 5 | X |
| 4 | C-4 | 367 | ◯ | 27 | X | 1.0 | 55 | 270 | 80 | 30 | 80 | 70 | 0 | 1 | 3 | X |
| 5 | C-5 | 378 | ◯ | 30 | X | 1.0 | 40 | 270 | 80 | 30 | 85 | 60 | −5 | 8 | 3 | X |
| 6 | C-6 | 372 | ◯ | 27 | X | 0.5 | 55 | 270 | 80 | 30 | 80 | 65 | −1 | 0 | 3 | X |

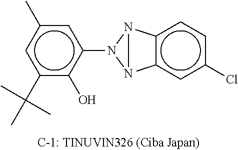

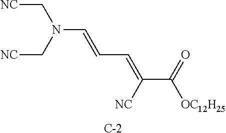

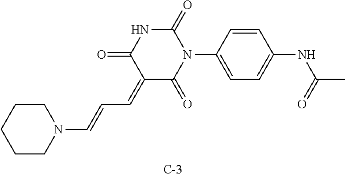

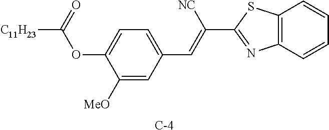

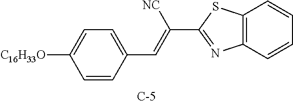

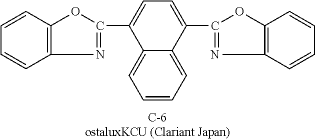

82

From the results shown in Table 1, it can be understood that the TN-mode liquid-crystal display devices of Examples 1 to 12 each having the polymer film of the invention to which a compound satisfying the above formulae (1) and (2) is added are all excellent in viewing angle characteristics and are yellowed little. In particular, it can be understood that the polymer films used in Examples 1 and 4 are excellent in all the points of viewing angle characteristics, yellowing resistance and lighffastness.

On the other hand, it can be understood that the TN-mode liquid-crystal display devices of Comparative Examples 1 to 6 each having a polymer film to which a UV absorbent not satisfying the above formula (1) and/or (2) are all inferior to the TN-mode liquid-crystal display devices of Examples in point of viewing angle characteristics and/or yellowing resistance.

### 5. Stretching of Polymer Film:

A polymer film was produced in the same manner as in Example 1, except that the stretching condition in the stretching step was varied and the stretching ratio was changed from 35% to 10%. The obtained polymer film had a negative ΔRe and a positive ΔRth, or that is, the film had optical properties satisfying the formulae (3) and (4). On the other hand, Re of the polymer film was 16 nm and Rth thereof was 55 nm. An alignment film and an optically anisotropic layer were formed on the polymer film in the same manner as above; and using this, a polarizing plate and a TN-mode liquid-crystal display device were produced and evaluated in the same manner as above. As a result, like in Example 1, the device was free from yellowing, but the viewing angle characteristics were not so good (“2” of the above evaluation criteria). From the result, it can be understood that when a film is produced by solution casting and when it is stretched in the machine direction while having a predetermined residual solvent amount, then the stretching had significant influences on Re and Rth of the polymer film. When the stretching ratio in the stretching step is more than 15%, then a polymer film of which Re and Rth each fall within a desired range can be stably produced.

On the other hand, the film was stretched under different stretching conditions at different stretching ratios, then the film was broken when the stretching ratio reached 120%. From the results, it can be understood that the stretching ratio in the stretching step is preferably at most 100%.

1. A polymer film comprising
at least one polymer as the main ingredient thereof, and
at least one compound that satisfies relational formulae (1) and (2), in an amount of from 0.2 to 20% by mass of said at least polymer; and
of which retardation in plane at a wavelength of λnm, Re(λ), and retardation along the thickness direction at a wavelength of λnm, Rth(λ) satisfy formulae (3), (4), (5) and (6):
360 nm≦λmax≦400 nm (1)
λ_{1/2}−λmax≦20 nm (2)
wherein λmax indicates the maximum absorption wavelength (unit: nm) of the compound, λ_{1/2}(λmax<λ_{1/2}) indicates the wavelength at which the absorption intensity at λmax is ½,
Re(450)−Re(550)≦0 nm (3)
Rth(450)−Rth(550)≧0 nm (4)
60 nm≦Re(550)≦100 nm (5)
40 nm≦Rth(550)≦80 nm (6)

2. The polymer film of claim 1, satisfying formulae (3′) and (4′):
−150 nm≦Re(450)−Re(550)≦0 nm (3′)
150 nm≧Rth(450)−Rth(550)≧0 nm (4′)

3. The polymer film of claim 1, satisfying formulae (3″) and (4″):
−50 nm≦Re(450)−Re(550)≦−3 nm (3″)
50 nm≧Rth(450)−Rth(550)≧3 nm (4″)

4. The polymer film of claim 1, wherein the compound is a merocyanine compound represented by formula (I), and λmax of the compound satisfies 370 nm≦λmax≦400 nm: 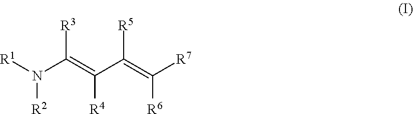
wherein N represents a nitrogen atom; and R¹ to R⁷ each represent a hydrogen atom or a substituent.

5. The polymer film of claim 4, wherein in formula (I), R¹ and R² each represent a substituted or unsubstituted alkyl group, and these may bond to each other to form a ring including the nitrogen atom; R⁶ and R⁷ each represent a substituent having a Hammett substituent constant σp of at least 0.2, or R⁶ and R⁷ may bond to each other to form a cyclic active methylene compound structure; and R³, R⁴ and R⁵ are hydrogen atoms.

6. The polymer film of claim 1, wherein the compound is a merocyanine compound represented by formula (Ia): 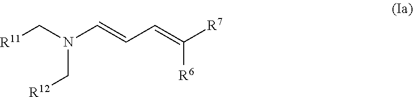
wherein R¹¹ and R¹² each represent an alkyl group, an aryl group, a cyano group or —COOR¹³, or they bond to each other to form a ring containing the nitrogen atom; R⁶ and R⁷ each represent a cyano group, —COOR¹⁴, or —SO₂R₁₅, or they bond to each other to form any of the following cyclic active methylene structures (Ia-1) to (Ia-6); R¹³, R¹⁴ and R¹⁵ each represent an alkyl group, an aryl group, or a heterocyclic group: 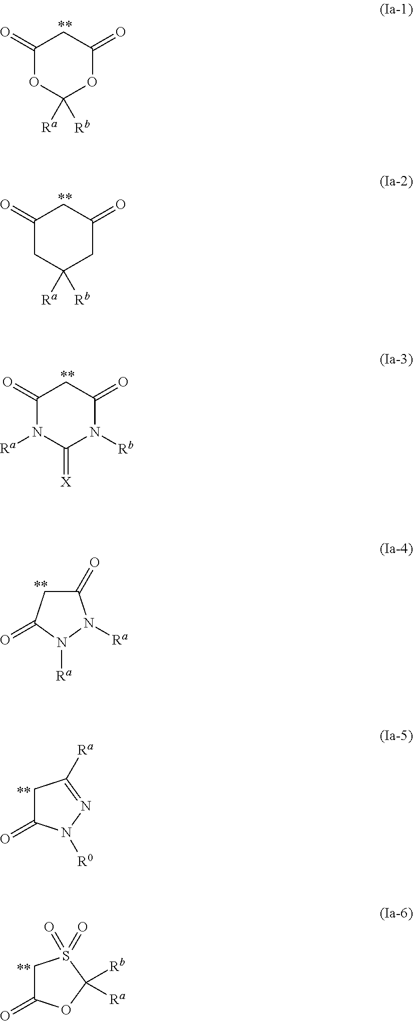
wherein each of “**” indicates the position at which the group bonds to formula (Ia); R^{a} and R^{b} each represent a hydrogen atom, or a C₁-C₂₀ alkyl group; and X represents an oxygen atom or a sulfur atom.

7. The polymer film of claim 6, wherein the merocyanine compound represented by formula (Ia) is a compound represented by formula (Ia-a), (Ia-b) or (Ia-c): 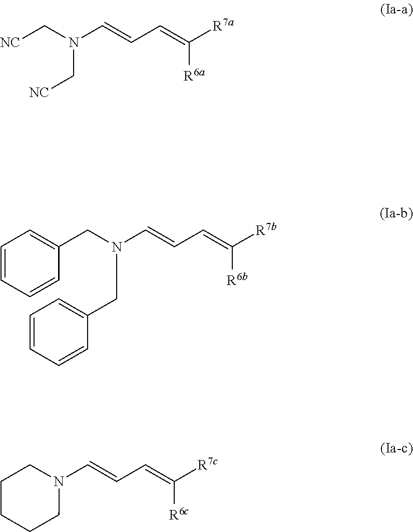
wherein R^{6a} and R^{7a}, R^{6b} and R^{7b}, and R^{6c} and R^{7c} have the same meanings as R⁶ and R⁷, respectively, in formula (Ia).

8. The polymer film of claim 1, wherein the compound is a benzodithiol compound represented by formula (II), and λmax of the compound satisfies 387 nm≦λmax 400 nm: 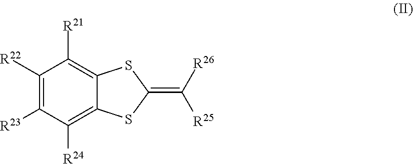
wherein S represents a sulfur atom; R²¹ to R²⁶ each represent a hydrogen atom or a substituent, and if possible, they may bond to each other to form a ring.

9. The polymer film of claim 1, wherein the compound is a benzodithiol compound represented by formula (IIa): 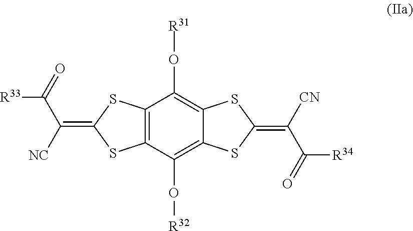
wherein R³¹ and R³² each represent a substituted or unsubstituted alkyl group; R³³ and R³⁴ each represent a substituted or unsubstituted alkyl group, or a substituted or unsubstituted alkoxy group; provided that one CH₂ and two CH₂'s not adjacent to each other in the alkyl group represented by R³¹ to R³⁴ may be replaced by an oxygen atom or a sulfur atom.

10. The polymer film of claim 1, wherein the polymer is a cellulose acylate satisfying formula (10):
2.70<SA+SB≦3.00 (10)
wherein SA represents a degree of substitution with an acetyl group; and SB represents a degree of substitution with any other acyl group than acetyl group.

11. A method for producing a polymer film comprising
at least one polymer as the main ingredient thereof, and
at least one compound that satisfies relational formulae (1) and (2), in an amount of from 0.2 to 20% by mass of said at least polymer; and
of which retardation in plane at a wavelength of λnm, Re(λ), and retardation along the thickness direction at a wavelength of λnm, Rth(λ) satisfy formulae (3), (4), (5), and 6;
360 nm≦λmax≦400 nm (1)
λ_{1/2}−λmax≦20 nm (2)
wherein λmax indicates the maximum absorption wavelength (unit: nm) of the compound, λ_{1/2}(λmax<λ_{1/2}) indicates the wavelength at which the absorption intensity at max is ½;
Re(450)−Re(550)≦0 nm (3)
Rth(450)−Rth(550)≧0 nm (4)
60 nm≦Re(550)≦100 nm (5)
40 nm≦Rth(550)≦80 nm (6)
the method, comprising:
casting a polymer solution that contains at least one polymer of the main ingredient thereof, and at least one compound satisfying relational formulae (1) and (2), in an amount of from 0.2 to 20% by mass of the polymer, to form a web;
stretching the web formed in the casting step, by from 4 to 100% along the machine direction while the residual solvent amount is from 100 to 300% by mass; and, and
drying, after the stretching step, the web at a web surface temperature of from 50 to 100 degrees Celsius while the residual volatile content of the web is from 100 to 10%:
360 nm≦λmax≦400 nm (1)
λ_{1/2}−λmax≦20 nm (2)
wherein λmax indicates the maximum absorption wavelength (unit: nm) of the compound, λ_{1/2}(λmax<λ_{1/2}) indicates the wavelength at which the absorption intensity at λmax is ½.

12. A retardation film comprising a polymer film, comprising:
at least one polymer as the main ingredient thereof, and
at least one compound that satisfies relational formulae (1) and (2), in an amount of from 0.2 to 20% by mass of said at least polymer; and
of which retardation in plane at a wavelength of λnm, Re(λ), and retardation along the thickness direction at a wavelength of λnm, Rth (λ) satisfy formulae (3), (4), (5) and (6);
360 nm≦λmax≦400 nm (1)
λ_{1/2}−λmax≦20 nm (2)
wherein λmax indicates the maximum absorption wavelength (unit: nm) of the compound, λ_{1/2} (λmax<λ_{1/2}) indicates the wavelength at which the absorption intensity at λmax is ½;
Re(450)−Re(550)≦0 nm (3)
Rth(450)−Rth(550)≧0 nm (4)
60 nm≦Re(550)≦100 nm (5)
40 nm≦Rth(550)≦80 nm (6)
and, as provided thereon, an optically anisotropic layer formed by curing a liquid-crystal composition.

13. A polarizing plate including a polymer film comprising:
at least one polymer as the main ingredient thereof, and
at least one compound that satisfies relational formulae (1) and (2), in an amount of from 0.2 to 20% by mass of said at least polymer; and
of which retardation in plane at a wavelength of λnm Re(λ) and retardation along the thickness direction at a wavelength of λnm, Rth(λ) satisfy formulae (3), (4), (5) and (6):
360 nm≦λmax≦400 nm (1)
λ_{1/2}−λmax≦20 nm (2)
wherein λmax indicates the maximum absorption wavelength (unit: nm) of the compound, λ_{1/2}(λmax<λ_{1/2}) indicates the wavelength at which the absorption intensity at λmax is ½;
Re(450)−Re(550)≦0 nm (3)
Rth(450)−Rth(550)≧0 nm (4)
60 nm≦Re(550)≦100 nm (5)
40 nm≦Rth(550)≦80 nm (6)
or a retardation film comprising said polymer film and, as provided thereon, an optically anisotropic layer formed by curing a liquid-crystal composition;
and a polarizing film, wherein the angle between the in-plane slow axis of the polymer film or the retardation film and the in-plane transmission axis of the polarizing film are parallel to each other.

14. A liquid-crystal display device at least having a polymer film comprising:
at least one polymer as the main ingredient thereof, and
at least one compound that satisfies relational formulae (1) and (2), in an amount of from 0.2 to 20% by mass of said at least polymer; and
of which retardation in plane at a wavelength of λnm, Re(λ), and retardation along the thickness direction at a wavelength of λnm Rth(λ) satisfy formulae (3), (4), (5) and (6);
360 nm≦λmax≦400 nm (1)
λ_{1/2}−λmax≦20 nm (2)
wherein λmax indicates the maximum absorption wavelength (unit: nm) of the compound λ_{1/2}(λmax<λ_{1/2}) indicates the wavelength at which the absorption intensity at λmax is ½;
Re(450)−Re(550)≦0 nm (3)
Rth(450)−Rth(550)≧0 nm (4)
60 nm≦Re(550)≦100 nm (5)
40 nm≦Rth(550)≦80 nm (6)

15. A TN-mode liquid-crystal display device at least having a retardation film including a polymer film comprising:
at least one polymer as the main ingredient thereof, and
at least on compound that satisfies relational formulae (1) and (2), in an amount of from about 0.2 to 20% by mass of said at least polymer; and
of which retardation in plane at a wavelength of λnm, Re(λ), and retardation along the thickness direction at a wavelength of λnm, Rth(λ) satisfy formulae (3), (4), (5) and (6);
360 nm≦λmax≦400 nm (1)
λ_{1/2}−λmax≦20 nm (2)
wherein λmax indicates the maximum absorption wavelength (unit: nm) of the compound, λ_{1/2} (λmax<λ_{1/2}) indicates the wavelength at which the absorption intensity at λmax is ½;
Re(450)−Re(550)≦0 nm (3)
Rth(450)−Rth(550)≧0 nm (4)
60 nm≦Re(550)≦100 nm (5)
40 nm≦Rth(550)≦80 nm (6)
and, as provided thereon, an optically anisotropic layer formed by curing a liquid-crystal composition.
